(19) United States
(12) Patent Application Publication
(10) Pub. No.: US 2025/0356025 A1
(43) Pub. Date: Nov. 20, 2025

(54) Risk Assessment Tool for Target Documents

(71) Applicant: The Government of the United States of America, as represented by the Secretary of Homeland Security, Washington, DC (US)

(72) Inventors: David Tillery, Dumfries, VA (US); David Hagerty, Annapolis, MD (US)

(73) Assignee: The Government of the United States of America, as represented by the Secretary of Homeland Security, Washington, DC (US)

(21) Appl. No.: 19/206,321

(22) Filed: May 13, 2025

Related U.S. Application Data
(60) Provisional application No. 63/647,446, filed on May 14, 2024.

(51) Int. Cl. G06F 21/57

(52) U.S. Cl. CPC G06F 21/577; G06F 2221/033

(57) ABSTRACT

A risk assessment tool generates a likelihood score based on an expertise score, acquisition capability score, fundability score, disclosure sufficiency score, and interest score. The likelihood score indicates how likely that technology will be used or adopted by the adverse party in a way that is harmful to a protected party. An impact severity scoring engine generates an impact severity score based on an impact to national security score, impact to national economy score, and strategic importance score. The impact severity score indicates a severity of impact to the protected party when the adverse party implements the target technology. A risk scoring engine generates a risk threshold curve on a graph and determines the overall risk score based on a risk threshold. The risk assessment tool issues a secrecy order when the risk score is above the risk threshold, and sends a communication to the author or publisher.

### CROSS-REFERENCE TO RELATED APPLICATIONS

This application is a nonprovisional application that claims the benefit of priority from U.S. Provisional Application No. 63/647,446 entitled “Risk Assessment Tool for Target Documents,” filed on May 14, 2024, the contents of which is incorporated herein by reference in its entirety.

### STATEMENT OF GOVERNMENT INTEREST

The present invention was made by employees of the United States Department of Homeland Security (DHS) in the performance of their official duties. The U.S. Government has certain rights in this invention.

### FIELD

Aspects of this technology relate to assessing risks associated with publication of a document.

### BACKGROUND

In February 2003, the President signed Executive Order 13286 that designated the Department of Homeland Security (DHS) a defense agency for the purpose of the Invention Secrecy Act (ISA), a tool to safeguard national security. The ISA provides DHS with the authority to prevent the publication or issuance of a patent application by the U.S. Patent and Trademark Office (USPTO) through the application of a Secrecy Order. Previously, DHS ISA Program implemented this policy through a network of ISA Reviewers throughout DHS and its components. ISA Reviewers were instructed to apply their expertise in forming a legal decision whether an application is detrimental to national security and therefore qualifies for a Secrecy Order.

A Secrecy Order is a restriction placed on a patent application that prevents it from entering the public domain based on national security concerns. Secrecy Orders are valid for 1-year and are reviewed annually and may be rescinded or modified anytime at the discretion of DHS. Secrecy Orders may be issued with or without a Permit that will allow for disclosure of information between the inventor and the Government to support the use of the invention in an official capacity. Secrecy Orders must have sufficient rationale and documentation in the form of a Secrecy Order Justification (SOJ) provided by the ISA Reviewer, primarily to support the review of petitions. A patent applicant whose application is subject to a secrecy order may petition for recission (total removal) of a Secrecy Order or modification of the Secrecy Order. Examples of modifications include but are not limited to: Requests to file the patent application in one or more foreign countries; or disclose the application to a prospective licensee of the technology. Petitions are considered case-by-case in conjunction with the ISA Reviewer's justification of the original Secrecy Order.

### SUMMARY

A risk assessment tool may comprise: a database for storing target documents and target records. The risk assessment tool may comprise a document processor for processing the document including (translation, classification, document integrity, etc.) The risk assessment tool may comprise a risk scoring engine for determining an overall risk to a protected party based on publication of the target document. The risk assessment tool may also comprise a communication platform configured to generate a communication to the author or publisher. The communication may identify the document is subject to a secrecy order. The communication platform may send the communication to the author or publisher.

### BRIEF DESCRIPTION OF THE DRAWINGS

FIG. 1 illustrates a schematic diagram of the risk assessment tool for target documents according to an embodiment.

FIG. 2 illustrates an exemplary target document data record according to an embodiment.

FIG. 3 illustrates a risk analysis matrix according to an embodiment.

FIG. 4 illustrates a process flow for risk assessment according to an embodiment.

FIG. 5 illustrates a computer architecture according to an embodiment.

FIG. 6 illustrates a diagram of a computer system according to an embodiment.

### DETAILED DESCRIPTION OF THE DRAWINGS

The risk assessment tool may comprise a computer. The computer can include one or more processors, memory, and non-transitory computer readable code stored in the memory. The code may be configured to cause the processor to execute a series of instructions, generate a series of modules or logic.

The risk assessment tool can serve as a platform having a modular risk element. Various different agencies can use the platform, with a customized or tailored risk element that the agency plugs into the platform and perform the corresponding customized assessment. For example, agencies such as DOD, DOE, DHS, USDA, etc. have different risk profiles because they have different mission spaces that they work with. Risk profiles of those different agencies can be plugged into the platform and applied. An example modular customization is provided below as table 1 describing an example likelihood criteria, and as table 2 describing an example impact criteria.

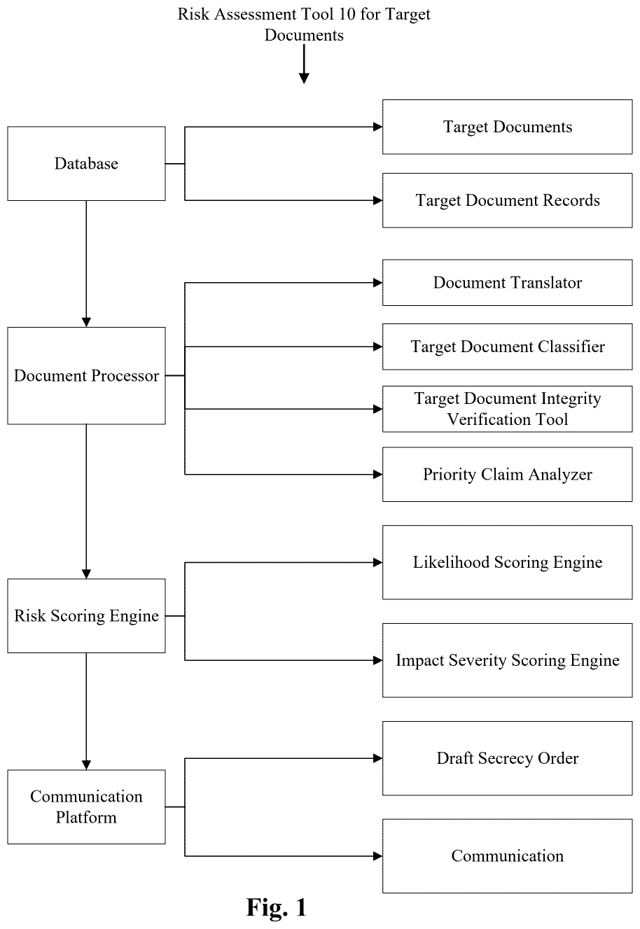

FIG. 1 illustrates a risk assessment tool 10, which may comprise a target document comprising target technology. A target document is a document designed for classification by the risk assessment tool. A target technology is technology and/or technical information in the target document. The target document may be written by an author. The target document may be publishable by a publisher. The risk assessment tool may comprise a database configured to store one or more target document records. The target document record may comprise the target document and other fields.

In some configurations, the risk assessment tool 10 is configured to determine risk to a protected party. A protected party is a party (individuals, groups, company, states, nations, governments, etc.) that be harmed if technology in the target document were made public. An adverse party is a party that would use the technology to harm the protected party.

The risk assessment tool may comprise document processor. The document processor may comprise a plurality of document process algorithms and programs to enable the risk scoring engine to analyze the document. For example, the document processor may comprise a document translator, target document classifier, target document integrity verification tool, priority claim analyzer, etc.

The document translator may be configured to: determine a language of the target document (English, Chinese, French, etc.); and translate the language of the target document to a preferred (second) language when the document is written in a language other than the second language. While the risk assessment tool can be programmed to process documents natively in any language; some configurations of the invention may be configured translate documents from non-preferred languages into the preferred language. For example, if the preferred language is English and the target document is written in German, the document translator may be configured to detect the target document is written in German and (optionally) translate the document (or a portion thereof) to English. The document translator may generate a translated copy of the document and store the translated copy in the target document record.

The target document classifier may be configured to classify the document into a specific type and order subtype. For example, the target document classifier could classify a document as a patent application, lease agreement, advertisement, blog article, receipt, product description, etc. The target document classifier may be configured to classify the target document into subclasses as well. For example, a patent could be classified by Patent Office classification, Art Unit, subject matter, etc.

The target document integrity verification tool may comprise a list of standard data fields that appear in a complete document of for a specific type. The target document integrity verification tool may be configured to determine whether the target document contains data in all standard data fields. The target document integrity verification tool may be configured to mark the target document as complete if the document contains data in all standard data fields; and mark the target document as incomplete if the document does not contain data in all standard data fields.

The priority claim analyzer may be configured to: determine there is a foreign priority claim in the target document; determine there is not a foreign priority claim in the target document; determine there is a domestic priority claim in the target document; and determine there is not a domestic priority claim in the target document. The priority claim analyzer may be configured to update the target document record to record the foreign priority claim.

The risk assessment tool 10 may comprise a risk scoring engine. The risk scoring engine may comprise a likelihood scoring engine and an impact severity scoring engine.

The likelihood scoring engine (LSE) may be configured to: determine an expertise score based on expertise required to implement the target technology; determine an acquisition capability score based on whether material and components could be readily acquired to implement the target technology; determine a fundability score based on an amount of funding required to implement the target technology; determine a disclosure sufficiency score based on how much disclosure details are missing from the document; and determine an interest score based on known or suspected interest levels in the technology to an adverse party.

The likelihood scoring engine may be configured to generate a likelihood score by performing a first mathematical operation on one or capabilities such as: expertise, acquisition capability, fundability, disclosure sufficiency, and interest. The likelihood scoring engine may generate a capability score such as an expertise score, acquisition capability score, fundability score, disclosure sufficiency score, and interest score. The likelihood score indicating how likely that technology in the target document will be used or adopted by the adverse party in a way that is harmful to a protected party. Examples of mathematical operations include arithmetic calculations, statistical calculations, and logical calculations.

### Expertise Scoring

The likelihood scoring engine may be further configured to: assign the target technology a design complexity rank of complex, moderate, or simple. The likelihood scoring engine may set a numerical equivalent for high, medium, and low, wherein the numerical equivalent for high is greater than the numerical equivalent for medium, and the numerical equivalent for medium is greater than numerical equivalent for low. The likelihood scoring engine may: set expertise score as low when the target technology has a design complexity ranked complex; set expertise score as medium when the target technology has a design complexity ranked medium; and set expertise score as high when the target technology has a design complexity ranked simple.

The likelihood scoring engine may be further configured to: assign the target technology a skill level rank of advanced, average, or simple. For example, embodiments can use a form of machine learning, artificial intelligence, or the like to analyze documentation of different technology types to learn (e.g., based on keywords and context) relative levels of skill/complexity described in the technology documentation (such as a set of patents in a given related art unit, or patent office classification code or subcode for that technology). The engine can set expertise score as low when the target technology has a technology skill level of advanced; set expertise score as medium when the target technology has a technology skill level of average; and set expertise score as high when the target technology has a technology skill level of simple. In an embodiment, the likelihood scoring engine can decide the design complexity rank by a classifier that has a library of complex, moderate, and simple exemplary patents and determine which group is most similar. The likelihood scoring engine also can be programmed by looking at a number of figures, average number of elements per figure, number of claims, numbers of claims in family, number of tables in the application, reading level of the patent using a reading level algorithm, etc.

The likelihood scoring engine may be further configured to assign the target technology a skill level rank of advanced when the target technology requires a subject matter expert with unique and specialized backgrounds that are not readily available. The likelihood scoring engine may be further configured assign the target technology a skill level rank of moderate when the target technology requires a technical background and an understanding of the target technology obtainable with moderate difficulty. The likelihood scoring engine may be further configured to assign the target technology a skill level rank of simple when target technology can be implemented by an individual without prior background or knowledge of the technology.

### Impact Severity Scoring Engine (ISE)

The impact severity scoring engine may be configured to determine a health security impact score indicating a severity of impact to health security of individuals in the protected party when the target technology is implemented by the adverse party. The impact severity scoring engine may be configured to determine a critical infrastructure score indicating a severity of impact to critical infrastructure of the protected party when the target technology is implemented by the adverse party. The impact severity scoring engine may be configured to determine a business operation interference score indicating a severity of impact to business operations of the protected party when the target technology is implemented by the adverse party. The impact severity scoring engine may be configured to generate an impact severity score by performing a second mathematical operation on the health security impact score; critical infrastructure score; and business operation interference score; the impact severity score indicating a severity of impact to the protected party when the adverse party implements the target technology. Examples of the second mathematical operations include arithmetic calculations, statistical calculations, and logical calculations. The first mathematical operation and the second mathematical operation may be the same.

### Health Security Scoring

The impact severity scoring engine may be further configured to determine an expected number of people are likely to be impacted by implementation of the target technology. The impact severity scoring engine may be configured to: assign the health security impact value a low score when the expected number of people is below X persons; assign the healthy security impact value a medium score when the expected number of people is below Y persons, but above X persons; assign the healthy security impact value a high score when the expected number of people is below Z persons, but above Y persons; and assign the healthy security impact value a catastrophic score when the expected number of people is above Z persons. The impact severity scoring engine may be configured to set a numerical equivalent for catastrophic, high, medium, and low, wherein the numerical equivalent for catastrophic is greater than numerical equivalent for high, the numerical equivalent for high is greater than the numerical equivalent for medium, and the numerical equivalent for medium is greater than numerical equivalent for low. The impact severity scoring engine may be configured to set Z greater than Y and Y greater than X; wherein X, Y, Z are natural numbers. In an embodiment, the impact severity scoring engine can determine the impact severity score based on a comparison of past events that utilized a given type of technology in our history, e.g., by using a form of machine learning, artificial intelligence, or the like to analyze documentation of past events. Technology that has been used or is known could be used to significantly injure a lot of people (or some people significantly get a higher rating).

The impact severity scoring engine may be further configured to: determine an expected severity of health impact for individuals in the protected party through implementation of the target technology by the adverse party. The impact severity scoring engine may be configured to assign the healthy security impact value a low score when the expected severity of health impact includes mild health implications for a small number of individuals.

impact severity scoring engine may be configured to assign the healthy security impact value a medium score when the expected severity of health impact includes: moderate health implications for a moderate number of individuals; moderate health implications for a small number of individuals; or mild health implications for a moderate number of individuals. The impact severity scoring engine may be configured to assign the health security impact value using different approaches to classify the different options. In an embodiment, the impact severity scoring engine contains on the order of 20 possible relative rankings, taking into account a severity of the condition and how many people were affected, providing the software with increased precision.

The impact severity scoring engine may be configured to assign the healthy security impact value a high score when the expected severity of health impact includes: severe health implications or long term health implications for a high number of individuals; severe health implications or long term health implications for a medium number of individuals; severe health implications or long term health implications for a small number of individuals; or mild or moderate health implications for a large number of individuals.

The impact severity scoring engine may be configured to assign the healthy security impact value a catastrophic score when the expected severity of health impact includes: loss of life for any number of individuals; and mild, moderate, severe or long term health implications for a catastrophic number of individuals.

The impact severity scoring engine may be configured to set a numerical equivalent for catastrophic, high, medium, and low, wherein the numerical equivalent for catastrophic is greater than numerical equivalent for high, the numerical equivalent for high is greater than the numerical equivalent for medium, and the numerical equivalent for medium is greater than numerical equivalent for low.

In some configurations, the impact severity scoring engine may comprise: a national security analyzer configured to determine an impact to national security score associated with publication of the target document; a national economy analyzer configured to determine an impact to national economy score associated with publication of the target document; and a strategic importance analyzer configured to determine strategic importance score for the targeted technology to an adverse party. The impact severity scoring engine may be configured to generate an impact severity score by performing a second mathematical operation on the impact to national security score, impact to national economy score, and strategic importance score. The impact severity score may indicate a severity of impact to the protected party when the adverse party implements the target technology.

### Risk Score

The risk scoring engine may be configured to determine an overall risk score to the protected party.

### Risk Threshold Curve

The risk scoring engine may be configured to generate a risk threshold curve on a graph having axes (e.g., an X axis and Y axis). The risk scoring engine may be configured to determine the risk score is below the risk threshold when the impact severity score and the likelihood score as expressed as a coordinate on the graph falls within an area bound by axes of the graph and the risk curve. The risk scoring engine may be configured to determine the risk score is above the risk threshold when the impact severity score and the likelihood score as expressed as a coordinate on the graph does not fall within the area bound by axes of the graph and the risk curve.

### Communication Platform

The risk assessment tool may comprise a communication platform. The communication platform may be configured to generate a draft secrecy order to the author or publisher not to publish the paper when the overall risk score is above the risk threshold. The communication platform may also conclude that a secrecy order is not needed when the overall risk score is below the risk threshold. The communication platform may send the draft secrecy order to a third party computer for approval, review, and editing, etc. The communication platform may be configured to receive an approval from the third party computer to transmit the secrecy order.

The communication platform may be configured to generate a final secrecy order or mark the draft secrecy as signed, final, etc. The communication platform may generate a communication to the author or publisher comprising the final secrecy order. The communication may identify the target document is subject to a secrecy order. The communication platform may send the communication to the author or publisher. The communication platform may be configured edit the target document record to record that the target document has been reviewed by the risk assessment tool; and edit the target document record to record that the communication has been sent to the author or publisher.

### Document Record

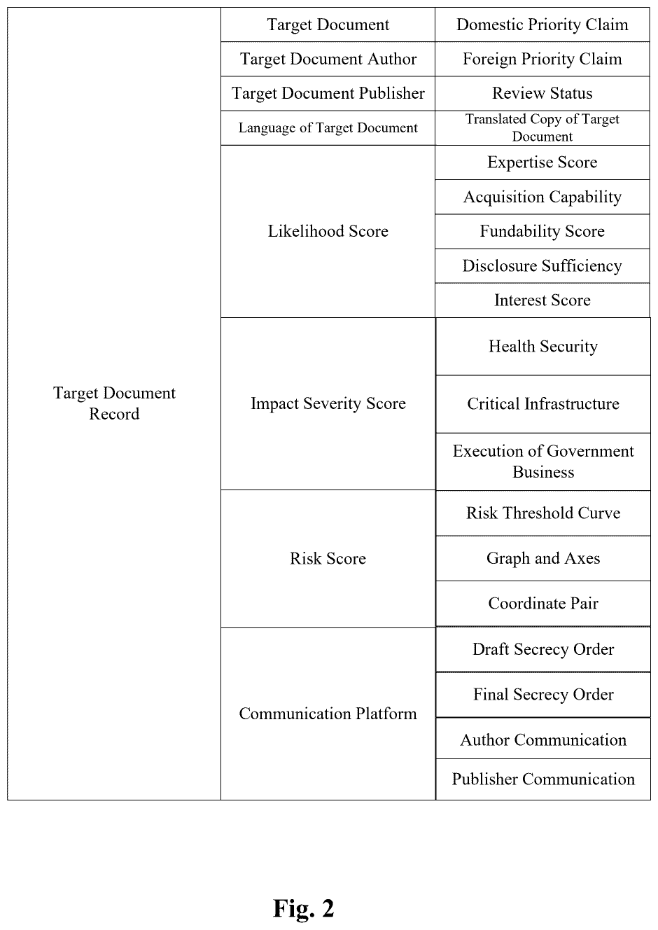

FIG. 2 illustrates an exemplary target document data record according to an embodiment. The target document record includes target document, target document author, target document publisher, language of target document, likelihood score, impact severity score, risk score, and communication platform. The target document record also includes domestic priority claim, foreign priority claim, review status, translated copy of target document, expertise score, acquisition capability, fundability score, disclosure sufficiency, interest score, health security, critical infrastructure, execution of government business, risk threshold curve, graph and axes, coordinate pair, draft secrecy order, final secrecy order, author communication, and publisher communication. The risk assessment tool can generate the target document record including the data for the various fields of the target document record.

### Training Library

The risk assessment tool may comprise a training library. The training library may comprise: a first set of training documents having a high impact on national security rank; the high impact on national security rank determined by a human; a second set of training documents having a medium impact on national security rank determined by a human; the medium impact on national security rank determined by a human; and a third set of training documents having a low impact on national security rank determined by a human; the low impact on national security rank determined by a human. Documents in the training library may be reviewed and scored by humans trained in risk assessment to the protected party. In another embodiment, the training library may comprise exemplary documents, such as patents, that are analyzed or classified using a form of machine learning, artificial intelligence, or the like to learn (e.g., based on keywords and context) relative impact levels as described in the technology documentation.

The national security analyzer may be further configured to determine a national security similarity level of the target document as compared to the first set, second set, and third set of training documents. The national security analyzer may be further configured to set a numerical equivalent for high, medium, and low, wherein the numerical equivalent for high is greater than the numerical equivalent for medium, and the numerical equivalent for medium is greater than numerical equivalent for low. The national security analyzer may be further configured to: set the impact to national security score as high when the target document is more similar to the first set of training documents; set the impact to national security score as medium when the target document is more similar to the second set of training documents; and set the impact to national security score as low when the target document is more similar to the third set of training documents.

The training library may also comprise: a first set of training documents having a high impact on national economy rank; the high impact on national economy rank determined by a human; a second set of training documents having a medium impact on national economy rank determined by a human; the medium impact on national economy rank determined by a human; and a third set of training documents having a low impact on national economy rank determined by a human; the low impact on national economy rank determined by a human. The national economy analyzer may be configured: to determine a national economy similarity level of the target document as compared to the first set, second set, and third set of training documents; set a numerical equivalent for high, medium, and low, wherein the numerical equivalent for high is greater than the numerical equivalent for medium, and the numerical equivalent for medium is greater than numerical equivalent for low; set the impact to national economy score as high when the target document is more similar to the first set of training documents; set the impact to national economy score as medium when the target document is more similar to the second set of training documents; and set the impact to national economy score as low when the target document is more similar to the third set of training documents.

The training library may also comprise a first set of training documents having a high impact on strategic importance rank; the high impact on strategic importance rank determined by a human; a second set of training documents having a medium impact on strategic importance rank determined by a human; the medium impact on strategic importance rank determined by a human; and a third set of training documents having a low impact on strategic importance rank determined by a human; the low impact on strategic importance rank determined by a human. The strategic importance analyzer may be configured to: determine a strategic importance similarity level of the target document as compared to the first set, second set, and third set of training documents; set a numerical equivalent for high, medium, and low, wherein the numerical equivalent for high is greater than the numerical equivalent for medium, and the numerical equivalent for medium is greater than numerical equivalent for low; set the impact to strategic importance score as high when the target document is more similar to the first set of training documents; set the impact to strategic importance score as medium when the target document is more similar to the second set of training documents; and set the impact to strategic importance score as low when the target document is more similar to the third set of training documents. In an embodiment, the training library may comprise exemplary documents that are analyzed or classified using a form of machine learning, artificial intelligence, or the like to learn (e.g., based on keywords and context) relative strategic levels as described in the technology documentation.

### Relative Scoring Module

The risk scoring engine may comprise a relative scoring module. The relative scoring module may be configured to adjust scoring for one or more of the scores calculated by the likelihood engine or impact severity score engine. The relative scoring module may be configured to adjust the calculated scoring based on a type of advertise party. For example, the likelihood scoring module may be calibrated to differentiate between a technology that has extensive costs requirements for an individual vs. a group vs. a nation-state. Additionally, the relative scoring module may be programmed to different between specific individuals, specific groups, and specific nation-states. For example, implementing a technology may be cost prohibitive to an individual but not to a nation-state. Or, acquisition capability may be very difficult for a group to acquire, but not for a nation-state. Or, in some cases, acquisition of certain raw materials for a specific nation-state may be difficult, but not for another nation-state.

The software may comprise or be connected to a database. The database may comprise entries for individuals, groups, and nation-states. The database may comprise a default value for a capability such as: expertise, acquisition capability, funding, complete design, and interest. One or more of these capabilities may comprise a sub-capability to allow the relative scoring module to differentiate for technologies for a specific advertise party.

For example: advertise group 1 may have a known history of engaging in armed, hand to hand conflict (physical raids-like a gang.) As a consequence, such a group may have a high interest in technology that removes fingerprints from guns. Adverse group 2 may conduct advertise activities through disinformation on social media. Adverse group 2 may have less interest in gun fingerprint removal technology. The likelihood scoring engine in combination with relative scoring module may be configured to generate an overall likelihood score that factors in specific attributes of plurality of individuals, groups, and nation-states. The likelihood scoring engine and relative scoring module may perform an arithmetic function on the plurality of scores for the individuals, groups, and nation-states. For example, the likelihood scoring module may compute a mean fundability.

For example, the risk assessment tool is analyzing technology that relates to atomic weapons. The likelihood scoring engine may compute a low total fundability score, because costs associated with building atomic weapons are very high for individuals, medium for most groups, and low for some nation-states. For example:
Overall Fundability Individual: Low
   100 Individuals Score Low Fundability
   20 Individuals Score Medium Fundability
   5 Individuals Score High Fundability
Overall Fundability Group: Medium
   50 Groups Score Low Fundability
   30 Groups Score Medium Fundability
   10 Groups Score High Fundability
Overall Fundability Nation-States: High
   20 Nation-States Score Low Fundability
   70 Nation-States Score Medium Fundability
   30 Nation-States Score High Fundability

In this example, the likelihood scoring engine can compute a fundability score separately for individuals, groups, and nation-states. The likelihood scoring engine may be configured to perform an average of each of the underlying advertise parties to arrive at the overall score. The risk assessment tool may comprise a zoom function that allows a user to view individual scoring for specific individuals, groups, nation-states.

Database entries for adverse parties may also comprise a threat level. The threat level may be based on total number of advertise actions, frequency of advertise actions, average severity of advertise actions, changes in advertise party resources, intelligence obtained relative to the advertise party, threats made by advertise party, etc. The LSE may be configured to track changes in threat level over time.

In the atomic weapon example, the likelihood scoring engine may compute an overall low likelihood score based on expertise, acquisition capability, funding, complete design, and interest. However, the likelihood scoring engine may increase the overall likelihood score to medium if the LSE determines that specific individuals having a high threat level have a high likelihood to take adverse action.

The risk assessment tool may comprise a natural language processor configured to generate a report. The report may list the specific individuals (or groups or nation-states) having a high threat level (e.g., flag these specific adverse parties.) The LSE may be configured to generate a reason code connected to the listed individuals. For example, the risk assessment tool may generate the following report:

Patent ABC contains technology that can be used to improve nuclear weapons. Overall likelihood score: low. Main scoring factors contributing to low score are high levels of expertise, difficulty in acquiring raw materials, high fundability requirements for equipment to machine the nuclear weapons, minimal disclosure sufficiency, and high interest. Adverse Party 3 is flagged: recently elevated threat level, high interest in atomic weapons, high financial means, recent intelligence shows a nuclear engineer associated with adverse party 3.

### Overall Fundability Individual: Low

I) 100 Individuals Score Low Fundability
II) 20 Individuals Score Medium Fundability
III) 5 Individuals Score High Fundability

### Overall Fundability Group: Medium

IV) 50 Groups Score Low Fundability
V) 30 Groups Score Medium Fundability
VI) 10 Groups Score High Fundability

### Overall Fundability Nation-States: High

VII) 20 Nation-States Score Low Fundability
VIII) 70 Nation-States Score Medium Fundability
IX) 30 Nation-States Score High Fundability

The communication platform may be configured to include the report with the draft secrecy order, send the report to administrator or third-party computer, etc.

Embodiments of the risk assessment tool described herein support providing recommendations for the USPTO to apply Secrecy Orders to patent applications, while ensuring consistent objective analysis of patent applications for identifying information that is detrimental to national security. The embodiments involve aspects including initial and overarching considerations to apply when reviewing a patent application, how to determine if a given patent application should be subject to a Secrecy Order, how to document analysis and rationale why a Secrecy Order is justified, and other technical bases for Secrecy Order recommendations.

Three aspects of an ISA Review include: 1) Initial Patent Assessment, 2) Applying Overarching Factors and 3) Conduct an ISA Risk Analysis. Review can be based on key words used to flag an application for areas of expertise. Tasks and steps for evaluating a patent application with the potential need of a Secrecy Order lead to a determination of whether or not to recommend a Secrecy Order and prepare a Secrecy Order Justification. Initial Patent Assessment-Quickly determine if an application requires a Risk Analysis or not; Check for Incomplete Information, Identify Priority Claims, Brief Initial Review, Confirm Assignment & Continue. Overarching Factors-Maintain awareness of underlying themes of National Security; Impact on National Security, Impact on National Economy, Strategic Value, Objective Analysis. ISA Risk Analysis-Conduct a risk analysis using one or more tools; ISA Risk Overview.

### Initial Patent Application Assessment

The risk assessment tool can conduct an initial assessment of the submitted documents to ensure the documents are complete, to confirm the patent is appropriately assigned for review, and to identify any priority claims that may affect the review process.

### Check for Incomplete Information

The risk assessment tool checks the file for corrupt (e.g., a non-accessible file) or incomplete information, e.g., missing pages or illegible content within the electronic documents. The risk assessment tool can notify the ISA Program Office for assistance immediately upon identifying this issue. The ISA Program Office works with the USPTO to resolve the issue.

### Identify Priority Claims

A patent application can claim the benefit of an earlier application known as a “Priority Claim.” The risk assessment tool can identify whether or not a priority claim exists and take the appropriate action. Priority claims are identified in the first couple paragraphs, the data sheet, or the biographic documents. If there is a foreign priority claim, the risk assessment tool can immediately send the application to the ISA Program Office. If there is a domestic priority claim, the risk assessment tool can take note and continue reviewing as normal.

### Brief Initial Review

The risk assessment tool can conduct a brief initial review to determine whether a recommendation can be made quickly. Some applications may have been referred in error due to trigger words such as “nuclear” or “explode” and some applications use information that is publicly available not subject to a Secrecy Order.

### Confirm Assignment & Continue

If the application requires further analysis, confirm the proper assignment(s). If a reassignment is required, the risk assessment tool can make multiple referrals to Organization Leads or forward to subordinate ISA Reviewers. A risk analysis and recommendation can still be made after making a reassignment.

### Overarching Factors

The risk assessment tool can consider a set of factors when assessing whether a Secrecy Order is appropriate for an application. The following section summarizes these overarching technical criteria along with additional resources for consideration.

### Impact on National Security

Secrecy Order technical analysis and rationales should include a firm basis in national security. National security encompasses national defense, foreign intelligence and counterintelligence, international and domestic security, and foreign relations and/or any new technology, adaptation, modification, or combination of technologies or inventions that results in being detrimental to among other categories 1) health security, 2) economic security, 3) critical infrastructure designed safeguards and systems, or 4) the execution of government business.”

### Impact on National Economy

The DHS Trade and Economic Security (TES) sub-office within the Office of Strategy, Policy, and Plans (PLCY) synchronizes the Department's economic security operational capabilities and policy development process. Additionally, in 2020, this office published a report that represents a collective understanding of U.S. economic security from a DHS perspective.¹ This report explains how economic security is related to national security and the DHS Mission. ¹ https://www.dhs.gov/sites/default/files/publications/21_0111_economic-security-assessment-annual-report.pdf

### Strategic Value

In October of 2020, White House Office of Science and Technology Policy (OSTP) released the National Strategy for Critical and Emerging Technologies (C&ET)². This strategy outlines the ways and means by which the United States, with its allies and partners, will continue to be the world leader in C&ET. To accomplish this enduring state, the United States will lead in the highest-priority C&ET areas, be a contributing peer with allies and partners in high-priority areas and manage risk in the remaining areas. This strategy informs the importance of these technologies and the need to protect some of them from entering the public domain. ² https://trumpwhitehouse.archives.gov/wp-content/uploads/2020/10/National-Strategy-for-CET.pdf

### Objective Analysis

The risk assessment tool applies an Objective Analysis, which corresponds to the overall basis to assess the risk an application presents to National Security, i.e., that a reasonable individual with similar background, knowledge, and expertise that when presented with the same information in a similar situation, would come to an equivalent conclusion.

### ISA Risk Analysis

### ISA Risk Overview

Rapid changes in social, economic, and technological arenas make the assessment of patent applications for national security concerns a complex and challenging task. Embodiments of the risk assessment tool provide a systematic approach using relevant national security criteria to determine if information within in a patent application requires the protection of a Secrecy Order. This analytic tool enables assessment of the risk to national security from the disclosure of the information contained in the application.

ISA Risk=Likelihood/Threat×Impact

### Definitions

Likelihood. A value (measure) of the possibility that an individual, group, or nation-state will adopt and/or use the information in a way that threatens national security from an objective perspective of an ISA Reviewer.

Threat Actors. Either a person or a group of people that take part in an action that is intended to cause harm to national security and is tied to likelihood.

Impact. An objective value (measure) of the severity of one or more national security adverse consequences that result from an event that makes use of information disclosed in or readily derived from the patent application.

ISA Risk. The combination of likelihood/threat and impact to assess whether a Secrecy Order is required to protect information within a patent application.

### Risk Matrix

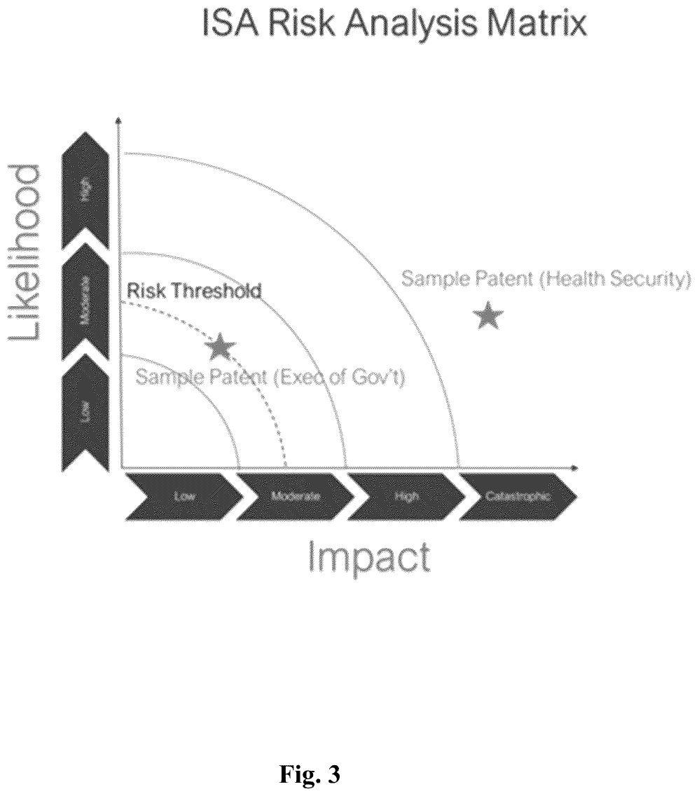

FIG. 3 illustrates a risk analysis matrix according to an embodiment. The risk assessment tool can generate the chart of the risk analysis matrix, and use the matrix to illustrate the assessment of whether a patent application is eligible for a Secrecy Order as well as assisting in crafting the Secrecy Order Justification. A determination to recommend a Secrecy Order can be based on the strength of the justification informed by this analytic tool.

### Using the Matrix

Using, e.g., likelihood criteria and impact criteria as set forth herein, the risk assessment tool determines the values for likelihood and impact that apply to information within the application.

For likelihood, the risk assessment tool plots the values for each element (Expertise, Acquisition Capability, Funding, Complete Design, Interest) on the matrix as it relates to the information in the application and potential for exploitation by a threat actor(s).

For impact, risk assessment tool plots the values for each element that applies (Health Security, Critical Infrastructure, Execution of Government), on the matrix as it relates to the information in the application.

The risk assessment tool plots those values on the Y (likelihood) and X (impact) axis of the matrix and identifies the highest values. If the combined values are above the acceptable risk threshold line, the application is likely eligible for a Secrecy Order. The risk assessment tool may use the logic derived from this analysis as foundation for the Secrecy Order Justification.

If the analysis results in values that are less than the risk threshold line, or, if additional information suggests the issuance of a Secrecy Order is not warranted, then no additional documentation or justification is required.

### Likelihood Criteria

The likelihood criteria (e.g., see Likelihood Criteria table below) provides a framework for considering the probability of an adversary using the information within a patent application to negatively impact national security. By analyzing the elements, such as required expertise, difficulty in acquiring materials, cost, complete design, and interest, the risk assessment tool can assess the possibility that the information can be used by our adversaries.

### Threat Actors

The likelihood aspect of risk is assessed in context with the threat actors most likely to benefit from an application being made publicly available. These actors have varying levels of resources, ideology, and strategic goals that influences the different information they may want to exploit. The risk assessment tool is informed by a basic awareness of the threat landscape to properly assess the likelihood that specific actors are willing or able to use the information contained in the application. Consideration of the threat actors is not an explicit requirement of assessing likelihood, but can be a useful construct for the risk assessment tool to consider during the analysis. An introduction to the variety of different threat actors is provided below:

State Sponsored Actors. A state is the political unit that has the ultimate authority or the sovereignty over an area of territory and the people in it. Since these actors hold the administrative power of a state, they have the ultimate authority in their decision-making procedure along with the right to possess the military power. In other words, state actors are the governments of the countries in the world.

Non-State Actors. An individual or organization that has significant political influence but is not allied to any particular country or state. They can be organizations or influential individuals that have the political, economic, or social capability to influence at a national or international level. They are not allies to any government or state, which makes it possible for them to work independently and allow them to influence and interfere with the actions of the state actors.

Violent non-state actors (VNSAs) are individuals or groups that are wholly or partly independent of governments and which threaten or use violence to achieve their goals. Examples of VNSAs that should be considered in the likelihood criteria in the ISA Risk Matrix are as follows:

International Terrorist Organizations. Individuals or groups who commit violent, criminal acts and who are inspired by, or associated with foreign terrorist organizations or nations (state-sponsored). Examples of International Terrorist Organizations include, Islamic State of Iraq and al-Sham (the Levant/Syria) (ISIS/ISIL), Al-Queda, Taliban, Boko Haram, Revolutionary Armed Forces of Colombia (FARC), etc.

Domestic Terrorist Organizations. Individuals and/or groups who commit violent, criminal acts to further ideological goals stemming from domestic influences, such as those of a political, religious, social, racial, or environmental nature.

Lone Offenders. Terrorist threats have evolved from large-group conspiracies toward lone-offender attacks. These individuals often radicalize online and mobilize to violence quickly. Without a clear group affiliation or guidance, lone offenders are challenging to identify, investigate, and disrupt.

Criminal Organizations. Those who are engaged in criminal activities and illegitimate activities. Their intentions are not politically motivated, rather motivated by financial gains, e.g., human and drug traffickers, narcotics, money laundering, etc.

Transnational Crime Organizations (TCO). These are groups of individuals who operate, wholly or in part, by illegal means. There is no single structure under which TCO group's function-they vary from hierarchies to clans, networks, cells, and may evolve into other structures. These groups are typically insular and protect their activities through corruption, violence, international commerce, complex communication mechanisms, and an organizational structure that spans national boundaries. Activities can include: drug trafficking, migrant smuggling, human trafficking, money laundering, firearms trafficking, illegal gambling, extortion, creating and selling counterfeit goods, smuggling of wildlife and cultural property, and cyber-crime, etc.

### Impact Criteria

Another component of risk is impact. Impact measures the severity of harm that results from detrimental use of the information from the application. The impact criteria set forth below provides a mechanism to assess the information within a patent application being used to negatively impact national security. If more than one criterion applies, the risk assessment tool can plot those values on the matrix to determine overall impact.

### Risk Summary

The likelihood criteria and impact criteria provide the risk assessment tool criteria in which to assign a qualitative value to the likelihood and impact lines. These values are then plotted along the matrix to assess its relationship to an acceptable level of risk. The risk threshold is set at a combined score of moderate/moderate for likelihood/impact, with Secrecy Orders considered for those that fall above, and no Secrecy Orders considered for those that fall below. However, the risk assessment tool can incorporate judgement relying on the knowledge, experience, and expertise of a subject matter expert in their analysis and rationale. For example, the risk assessment tool can consider whether a reasonable individual with similar background, knowledge, training, and expertise when presented with the same information, would come to the equivalent objective conclusion.

### Producing an Effective Justification Report

If the analysis supports a Secrecy Order recommendation, the risk assessment tool prepares a Secrecy Order Justification (SOJ). The central aspect of a SOJ is its link to national security, however, an Effective Justification further explains why the Government should keep the patent application from disclosure in a manner that is reasonable, objective, and based on facts. These three elements will ensure that DHS's rationale supports the recommendation of a Secrecy Order and will be valuable resource for the Department during the annual review cycle or in the event of a petition.

### Elements of an Effective Justification:

Facts. A good justification will contain facts, either in the form of quotations taken directly from the patent application itself (for unclassified information), or referenced by page number, paragraph, line-item (for information subject to a Secrecy Order). This information helps support a Secrecy Order Justification grounded on facts rather than assumptions or speculation. Without facts from the patent application, it will be more difficult to understand the logic of a Secrecy Order. It is important that a Secrecy Order Justification convey relevant facts or evidence, objective reasonable judgement, and explain the uniqueness of the information relative to what is publicly known.

Uniqueness. A good justification will demonstrate that the information (e.g., technology) is not present in the public domain, because a Secrecy Orders is designed to protect information so it does not become publicly available. If the information is already present in the public domain, the Secrecy Order may be questioned. Good justifications will be sure to address this aspect of the technology or information in the application to avoid a dispute.

Reasonability. A good justification as practical explains which portion(s) of the application pose a national security concern and explains why national security would be harmed by release of the information. The justification objectively explains why it is reasonable based on the risk, likelihood, and impact that DHS recommend imposition of a Secrecy Order. A final sentence/conclusion of the Justification will effectively guide the reader to understand how the unique technology is a risk to a specific element of national security with the documented authority to protect it. This concluding statement should be unambiguous and guide the reader to a logical conclusion that a Secrecy Order is necessary to protect national security.

Permit A As part of the Secrecy Order Justification template, the risk assessment tool also can identify if the patent application should be issued a Permit A by the USPTO. Permit A will allow the Government to use the information in the application in an official capacity through allowing the inventor to disclose it, (see Appendix A for a copy of a Permit A). No permit would fully prevent further dissemination of the information without exceptions or exclusions. Permits may also be negotiated or issued at a later time.

### Permit A

Permit for Disclosing to Government Employees and other Specified Persons. The principals designated in this Order are authorized to disclose the subject matter to any person of the classes' hereafter specified if such person is known to the principal disclosing to be concerned-directly-in an-official-capacity with-the subject matter provided that all reasonable safeguards are taken to otherwise protect the invention from unauthorized disclosure. The specified classes are:
any officer or employee of any department, independent agency or bureau of the government of the United States; or
any person designated specifically by the head of any department, independent agency or bureau of the government of the United States, or by his duly authorized subordinate, as a proper individual to receive the subject matter.

Principals under this Order are further authorized to disclose the subject matter of this application to the minimum necessary number of persons of known loyalty and discretion, employed by or working with the principals or their licensees and whose duties involve cooperation in the development, manufacture or use of the subject matter by or for the Government of the United States, provided such persons are advised of the issuance of this Order.

The provisions of this permit do not in any way lessen responsibility for the security of the subject matter as imposed by any government contract or the provisions of existing laws relating to espionage and national security.

TABLE 1
Likelihood Criteria

| Likelihood | Low | Moderate | High |
|---|---|---|---|
| Expertise | Complex design | Moderate design | Simple design that |
| | which requires | requirements which | can easily be |
| | subject matter | require technical | implemented by an |
| | experts, or SME(s), | background(s) and | individual without |
| | with unique and | understanding of the | prior background or |
| | specialized | technology that could | knowledge of the |
| | backgrounds that are | be obtained with | technology. |
| | not readily available. | moderate difficulty. | |
| Acquisition | Requires rare | Requires uncommon | Uses common |
| Capability | materials or | materials or | materials or |
| | components that are | components that are | components that are |
| | heavily regulated, | regulated or could be | easy to source and |
| | monitored, or | sourced through | acquire. |
| | controlled. | illicit/untraceable | |
| | | means. | |
| Funding | Extensive cost | Moderate cost | Minimal to no cost |
| | requirements or | requirements or | requirements or |
| | investments in | investments in | investments in |
| | infrastructure | infrastructure | infrastructure |
| | required. | required. | required. |
| Complete Design | Additional design | Additional design | The technology could |
| | elements to fully | elements to fully | be fully implemented |
| | implement the | implement the | as presented in the |
| | technology are not | technology could be | specifications or |
| | readily available. | acquired with a | design elements |
| | | moderate amount of | could easily be |
| | | difficulty | acquired. |
| Interest | The technology is not | The technology is a | The technology has a |
| | a perceived | perceived technology | broad appeal and is a |
| | technology of interest | of interest of | technology of interest |
| | for individual, group, | acquisition of at least | for acquisition among |
| | or nation-state for | one category of | most categories of |
| | acquisition or use. | individual, group, or | individuals, groups, |
| | | nation-state use. | or nation-states. |

TABLE 2
Impact Criteria

| Impact | Low | Moderate | High | Catastrophic |
|---|---|---|---|---|
| Health Security | Low numbers | Moderate health | Resulting in | Catastrophic |
| | and/or mild | and safety | severe/long- | numbers of |
| | health | impact and/or | term illness | illnesses or loss |
| | implications for | on medium | and/or death to | of life. |
| | small number of | number of | a high number | |
| | individuals. | individuals. | of individuals | |
| Critical | Moderate | High resources | Significant | Widespread or |
| Infrastructure | resources that | to address | resources to | long-term shut |
| | need to be | operational | address | down of ops |
| | committed to | challenges. | operational | severely |
| | address | Larger/multiple | issues. | impacting |
| | operational issue. | operational | Deep and/or | mission/life. |
| | Minor | inefficiency(s). | sustained | No operational |
| | operational | Long timeframe | operational | resiliency. |
| | inefficiency. | for | interruptions. | |
| | Short term | reconstitution of | Significant time | |
| | impact on | operations. | for | |
| | reconstitution. | | reconstitution. | |
| Execution of Gov't | Minor | Larger/multiple | Deep and/or | Widespread or |
| Business | operational | operational | sustained | long-term shut |
| | inefficiency | inefficiency(s) | operational | down of |
| | Short term | Long time | interruptions | operations |
| | impact on | frame for | Significant time | severely |
| | reconstitution | reconstitution of | for | impacting |
| | | ops | reconstitution of | mission/life |
| | | | ops | No operational |
| | | | | resiliency |

### Definitions

Acceptable Risk—The risk assessment tool recognizes a specific patent's acceptable risk can vary from a strict formula. The risk assessment tool can estimate that any patent application, that falls on a combined scale of moderate to catastrophic in likelihood and impact, is likely eligible for a Secrecy Order, or a more in-depth analysis at a minimum.

Impact—The severity of the consequences that are the direct result of the technology adopted and/or used in a way that threatens national security in accordance with an Objective Analysis.

Initial Patent Assessment—When a patent undergoes review, considerations should immediately be made as follows: Incomplete Information, Proper Assignment, and Foreign Patents or Parent-Child Foreign Patents.

Likelihood—The chances that individuals, groups, or nation-states will adopt and/or use the technology in a way that threatens national security in accordance with an Objective Analysis. This includes Expertise, Acquisition Capability, Funding, Complete Design, and Intention.

No Permit—Secrecy Orders may be placed on a patent application without a permit, i.e., inventors are prohibited from disclosing the information in the application and restricted from foreign filing.

Objective Analysis—An Objective Analysis is the overall basis to assess the risk a Patent Application presents to National Security, i.e., that a reasonable individual with similar background, knowledge, and expertise when presented with the same information in a similar situation, would come to an equivalent conclusion.

Permit A-Permit A will allow the inventor to disclose information with an authorized Government official in an official capacity of their duties and is useful when the technology may be developed for government purposes only.

Risk Matrix—The risk assessment tool can use a matrix to assess if a patent application might be eligible for a Secrecy Order as well as assisting in crafting the Secrecy Order Justification. The final determination to recommend a Secrecy Order is based on the quality and strength of the Justification informed by this analytic tool.

Secrecy Not Recommended—A designation made on a patent when a Secrecy Order is not recommended for that particular patent application.

Secrecy Order—A Secrecy Order is a restriction placed on a patent application that prevents it from entering the public domain based on national security concerns. The Secrecy Order is valid for 1-year and must be reviewed annually. Secrecy Orders may be rescinded at any time at the discretion of the requesting agency. Once rescinded, the application is granted an official patent and the 20-year protection on the invention begins at that time.

Secrecy Order Justification—A Secrecy Order Justification is a written description of the rationale and reasoning behind recommending a Secrecy Order.

APPENDIX E: Acronyms

| Acronym | Definition |
|---|---|
| C&ET | Critical and Emerging Technologies |
| DHS | Department of Homeland Security |
| FARC | Revolutionary Armed Forces of Colombia |
| ISA | Invention Secrecy Act |
| ISIS/ISIL | Islamic State of Iraq and al-Sham (the Levant/Syria) |
| OGC | Office of General Counsel |
| OSTP | Office of Science and Technology Policy |
| PLCY | Strategy, Policy, Plans |
| TCO | Transnational Crime Organization |
| TES | Trade and Economic Security |
| USPTO | United States Patent and Trademark Office |
| VNSA | Violent Non-State Actors |

Embodiments can incorporate automation, artificial intelligence, and machine learning (AI/ML) into the risk assessment tool, leveraging current-day technology to yield a dynamic, agile, real-time, autonomous ISA operating and patent application review platform. The platform can use tools and products that leverage AI/ML technology to perform functions. These tools may include data science toolkits (i.e., combined offerings for applied mathematical statistics) and visualization tools to explore data, to understand model performance, and to present results. Other new tools can include frameworks that provide pre-built architectures and models to reduce the time and effort needed for future development.

The risk assessment tool can incorporate an AI solution by using available data sets, identifying data quality problems, and deriving initial insights into the data and perspectives on a data plan. Data wrangling and preparation are used to construct a working data set from initial raw data into a format that a model(s) can use. This step can be tedious but is critically important to develop a model that achieves the overall goals. AI solutions can include a clear and precise understanding of the ISA process being automated and the desired outcome. Data serves as the foundation of the AI solution. The data files can be verifiably factual. Data screening is an important, though time-consuming, phase of the AI lifecycle.

Modeling: Test the data sets to determine the right model. The model can be trained, tested, evaluated, and retrained, and may result in the development of different models to determine the best model as well as the settings that achieve the most efficient process.

Evaluation: Use relevant evaluation metrics to assess the new models and data sources to ensure minimum goals and objectives are achieved.

Move to production: Once a model is stable and gains an Authority to Operate (ATO), it can be deployed into a production environment.

Monitor model output: The first live data cycle of patent applications can be manually reviewed to ensure the capabilities function as designed. This is commonly known as AI generalization, or the model's ability to adapt properly to new, previously unseen data. In production, models can be continuously monitored for all changes over time to ensure proper operation and oversight.

As with any logic and software development, an agile approach can be used with the risk assessment tool, with evaluation sprints to continually retrain and refresh the model, as part of the overall operational platform of the risk assessment tool. The platform can use rigorous and continuous monitoring and maintenance to continue to perform within its trained parameters, to meet the desired specific outcomes, and to produce accurate recommendations.

The risk assessment tool can be implemented in a computing system having various system attributes. In an embodiment, the computing system has a system computational power to run programs, algorithms, scripts, and the like as needed and directed herein to implement the various features, modules, components, and other aspects of the risk assessment tool. The risk assessment tool includes Data Storage Capability for system architecture, file management, and data tags. Once a Secrecy Order (SO) has been issued, the Patent Application (PA) can be removed from the ISA system and archived in a secure storage of the risk assessment tool.

The risk assessment tool can include a system log file or similar measures that are used to prove with evidence that certain files were deleted, or otherwise show, e.g., that the PA that was removed from the ISA system, is no longer available, and cannot be recovered. The risk assessment tool can include measures that can prove with evidence that PAs have been disclosed only to authorized individuals and that those individuals have signed the required acknowledgement forms (see workflow capabilities for further detail on acknowledgement forms). For example, the risk assessment tool can ensure that pdf files are encrypted and the only way to open those files is through the system in which a user has logged in (based on a username/password, PIV card, or the like) so that user credentials serve to unlock the encryption.

The risk assessment tool can include documentation at all levels of system architecture, networking, security, etc., that explain how data is utilized at each stage of the process and workflow. System training data supports a virtual, self-paced, and remote accessible course. The risk assessment tool allows end users to report issues encountered with the ISA system or PA processing, by capturing such reports in a centralized management system of the risk assessment tool. The risk assessment tool can interface with external storage (e.g., Drop Box and the like) to enable users such as system admins, ISA PMOs, and the like to add files to the system deemed appropriate for inclusion in search databanks. Examples include threat reports provided by users, or other public information found. The risk assessment tool can check the USPTO periodically, to re-identify or re-tag patent applications into awarded patents once they have become public. (This “tag” associated with the information will determine certain types of access controls and usage of the information).

The risk assessment tool enables capabilities of a workflow management tool. The risk assessment tool is able to conduct multiple workflow paths of a single Patent Application (PA) that can be reviewed by more than one organization/individual. For example, the risk assessment tool can receive feedback from one or more organizations reviewing a PA, which can include assignments to one or more individuals within that organization. These reviews can be conducted independently and later returned to the ISA PMO. The risk assessment tool provides the ability to “unlock” a completed ISA Review case and restart the actual workflow of an ISA Review of a Patent Application in support of an Annual Review process. The risk assessment tool can track and maintain the date/time of case assignments at the organization/individual level and compute the amount of time that is remaining to finalize the ISA Review. The risk assessment tool includes capabilities to, e.g., capture issues associated with the review process ex: Bob is consulting Commerce etc., and the ability to build a package of working papers of the patent application with associated information to be transferred to the SCIF, if needed. The risk assessment tool allows inclusion of attachments needed to process an ISA Review. The risk assessment tool enables users to “select” a relevant resource link; if selected, the information is downloaded and saved in the system. The risk assessment tool provides a capability to visualize information in graphical form, with the ability drill down within graphics/widgets to see the data that underlies it. The risk assessment tool provides the ability to determine the status of a PA at every stage of review through completion. The risk assessment tool provides the ability for users to notify each other, e.g., to “ping” individuals who have been assign a PA case that their action is needed. The risk assessment tool provides the ability for users to alert and communicate with other users, such as the ISA PMO, regarding a status of the review, ask questions, or otherwise make comments/notes. The risk assessment tool can check whether such notes from users divulge relevant information from the patent application, e.g., the risk assessment tool can scan the notes for cut-and-paste sections from the patent application. The risk assessment tool can provide additional warning messages for users to double-check they are not including items that are not allowed. The risk assessment tool also can capture user inputs and assessments of patent applications relative to national security. The risk assessment tool includes the capability to allow users to edit attachments within the system under specific parameters that are based on user role. e.g., an ISA PMO or OGC user roles can “finalize” a document, whereas other users can edit (the risk assessment tool keeping those edits in a track changes format).

In an embodiment, the risk assessment tool enables workflow for an ISA Review of a Patent Application. The risk assessment tool can facilitate direct system level communication with the USPTO for patent application ingest and new case assignments. For example, the risk assessment tool ingests patent applications from the USPTO directly without an individual performing a separate action. This eliminates manual work which reduces overall manpower requirements, reduces the possibility of human error and rework, and supports real-time transfer of patent applications, and gives users more time to review (e.g., based on a 90-day deadline).

The risk assessment tool can determine if a patent application sent from the USPTO is complete (e.g., perform an initial assessment). In an embodiment, the risk assessment tool uses an AI solution to determine if a pdf file of the patent application is corrupted, if all sections are present, or if the file is missing elements. In such situations, the risk assessment tool can send a flag to the PMO. Early determination of patent application completeness prevents assignments from being made with incomplete information, enables rapid turnaround time if a problem is found, e.g., enabling a full 90-day window to review a patent application.

The risk assessment tool can perform text extraction from a PDF document (patent application) so that it is usable by system tools of the risk assessment tool. In an embodiment, the risk assessment tool converts the patent application to a text-readable form for easier viewing and manipulation. The risk assessment tool protects the extracted text under the same safeguards as the actual pdf patent application (encryption, evidence of disclosure, etc.). Text extraction enables the risk assessment tool to reduce file storage requirements by potentially avoiding a need to store the original pdf. The text extraction also enables faster computations of processing and search algorithms.

In an embodiment, the risk assessment tool determines if a patent application is of foreign origin(s), e.g., during an initial assessment process. The risk assessment tool can perform the determination by scanning the application to determine if the patent has a foreign origin, in which case the patent application can be flagged for scrutiny if it was going to get a SO. The risk assessment tool can check if USPTO forms include a country code. The risk assessment tool can flag a PMO about the application responsive to the determination of foreign origin. Performing this determination early enables the risk assessment tool to provide the benefit of preventing assignments from being made for patent applications that are of foreign origin. Early detection reduces labor burdens on SMEs and the ISA PMO.

The risk assessment tool can determine if there are domestic priority claims, and provide copies of patents that are in the public domain (e.g., as part of an initial assessment). In an embodiment, the risk assessment tool identifies if there are domestic priority claims, and cross reference for similarities/differences. The tool can identify prior art that is cited/listed in the priority claim, and cross reference for similarities/differences. The tool also can cross reference the patent application to other patents that are currently in the public domain, and provide document comparison (similar to MS Word Compare functionality).

In an embodiment, the risk assessment tool determines that the patent application/information being reviewed is found to be in the public domain, and recommends with a high degree of certainty that a secrecy order should not be placed on it (e.g., based on a policy decision to likely not place a secrecy order on a patent application (regardless of its threat to national security), if the information contained in that patent application is already in the public domain). The risk assessment tool can assess similarities between patent applications (e.g., based on an AI language model), and determine whether a given patent application exceeds a similarity threshold with information from another patent application already in the public domain, to indicate that the given patent application also should be deemed no secrecy order (based on the similarity) and eliminated from the review process. The risk assessment tool can perform the analysis and generate a report with the recommendation of yes/no secrecy order, while also allowing input from a human to make the ultimate determination based on the generated report from the risk assessment tool.

The risk assessment tool can associate a patent application with a technology category, e.g., as part of an initial assessment. For example, the tool analyzes the patent application and determines an associated tech category. The risk assessment tool can use the tech category to assign the patent application to appropriate SMEs for review. The risk assessment tool can serve as a learning AI system by incorporating machine learning (e.g., using a 1:n relationship) applicable to the tech category. Associating the tech category enables the risk assessment tool to enable program reporting and big picture analysis of types of patent applications, SOs, etc. The risk assessment tool provides transparency in allowing the algorithm, for linking a patent application to a tech category, to be viewed/understood. The risk assessment tool can generate a feedback loop of machine learning to the technology category capability (and other capabilities) that can incorporate human input (e.g., human input to approve/disapprove suggested algorithm modifications).

The risk assessment tool can facilitate the assignment of a patent application to a human reviewer(s), e.g., as part of an initial assessment, or as part of generating a feedback loop for machine learning to incorporate human input to receive suggested algorithm modifications as part of the learning or training process. In an embodiment, the risk assessment tool compares patent application contents with a human's area of expertise and previous assignments to determine a best fit. The risk assessment tool can use a result of the tech category assigned, and/or previous patent applications that have been assigned to a specific reviewer, in such comparisons. Such facilitated assignment and incorporation feedback can save tremendous amounts of time and effort, and reduce a level of human error.

Embodiments of the risk assessment tool can request an acknowledgement from users, and can require a signed disclosure from users before disclosing a patent application. For example, the risk assessment tool can lock a patent application from viewing by any person attempting to open it, until that person has signed an “acknowledgement form” received by the risk assessment tool. The risk assessment tool can maintain acknowledgement forms and a list of individuals who have opened the PA, and the risk assessment tool can transmit such information as needed. In an embodiment, the risk assessment tool allows a user to open a PA multiple times responsive to the user signing the acknowledgement form once.

The risk assessment tool can capture user responses, such as a manual review of the patent application. The risk assessment tool can make user responses visible to other users, such as an ISA PMO. The risk assessment tool can provide a centralized point of contact for final adjudication. The risk assessment tool can send and receive communications, such as final recommendations, appropriate files, memos, etc. directly to the USPTO by the system itself (after all appropriate approvals have been made in the system) without the need for human involvement. Such requesting, capturing, ingesting, incorporating, transmitting, responding, sending, receiving, and other such functionality can be provided by a communication platform of the risk assessment tool.

The risk assessment tool includes a risk scoring engine, which can perform tasks related to risk, such as risk assessment. The risk assessment tool also includes a likelihood scoring engine to determine the likelihood values (expertise, acquisition capability, funding, complete design, interest) for a patent application, e.g., as part of performing the risk assessment. The risk assessment tool can make use of the engines, likelihood values, and other features described herein to replicate a decision-making process of a SME in this area. Such processes performed by the risk assessment tool include providing explainable AI descriptions (not just values) for judgements on likelihood criteria, capturing values assigned to impact future likelihood determinations, and the like as described herein. The risk assessment tool can determine unique values that can be applied to each unique patent, e.g., based on key words, analysis of other comparable patents (e.g., based on AI learning, language analysis, or other tools). The risk assessment tool can select what threat to rate the values against (nation state, crime organization, etc.) which can impact the values. The risk assessment tool can use threat vectors (spoke and hub) to document the profile of where the threat values come from.

As part of risk assessment, the risk assessment tool can determine the impact criteria (health security, critical infrastructure, execution of government business) for a patent application. The risk assessment tool can provide explainable AI description for judgements on likelihood criteria, and provide explainable AI (capability to document how it reached the conclusion for the likelihood score) description for judgements on likelihood criteria. The risk assessment tool can capture values assigned to impact future likelihood determinations. This provides the risk assessment tool with capabilities of a risk-based model for national security threats, and supports consistency in analysis and decision-making processes by utilizing pre-established data sources/benchmarks/criteria.

The risk assessment tool includes a risk scoring engine, which can calculate overall risk value based on likelihood and impact values and assign low, medium, or high-risk assessment to patent application (Risk Assessment). The risk scoring engine can calculate overall risk score from impact and likelihood assessments. The risk scoring engine also can accept manual input for such scores, and can create a visual display of the values (e.g., generate a risk threshold curve on a chart/graph). The risk scoring engine can calculate impact and likelihood assessments in an automated fashion to support consistency in analysis and decision-making processes by utilizing pre-established data sources/benchmarks/criteria.

In an embodiment, the risk assessment tool has the ability to interface with a website's API to run queries, capture the information it returns, and displays it within the system. The risk assessment tool system can read the patent application to first determine the tech category and/or relevant keywords, then, it can interface with an external website's Application Programming Interface (API) to run 1 or more queries, then download/display that information into the risk assessment tool system, which also can make that information visible by users on the risk assessment tool. Furthermore, the risk assessment tool can accumulate data about how to run these queries to make them more relevant. For example, the risk assessment tool can analyze queries (e.g., using machine learning tools) to inform the risk profile to understand what makes a patent application a national security issue. Accordingly, the risk assessment tool supports multiple aspects of the review process from determining the patent application's position within the public domain, the ability to provide references and links to relevant information that can support ISA reviews, establish a data library of information relevant to tech categories, and enable a learning model of technology and threats to enhance the risk assessment tool system's overall performance.

The communication platform of the risk assessment tool also enables functionality to facilitate risk assessment, e.g., by providing background data to support risk determinations (risk assessment). The communication platform can capture supporting data from trusted sources, and communicate the supporting data to the risk assessment tool to make the supporting data available to users and/or can append the supporting data to a record associated with the items undergoing review (e.g., the patent application). The communication platform can enable user access to information and comparisons provided by AI solutions of the risk assessment tool, to assist in risk determinations. If a Secrecy Order is issued, the communication platform of the risk assessment tool can download references from the links, and archive the references along with the case file associated with the item undergoing review.

The risk assessment tool includes a scoring engine (e.g., a likelihood scoring engine, an impact severity scoring engine, a risk scoring engine, and the like) that can quantify a relative level of risk of a target document (such as a patent application). In an embodiment, the scoring engine tags the patent application with “indicators” that are associated with high-risk patents (or low-risk patents), as part of a risk assessment technique. The risk assessment tool (e.g., via a scoring engine) can analyze and learn from documents that have previously been subjected to a secrecy order (SO). In an embodiment, the scoring engine identifies and displays indicators or trends in key words found in patent applications that have been given a SO in the past. The scoring engine can display the indicators or trends along with context/relevancy/disclaimer, to provide an understanding of why the indicators or trends are relevant and how the risk assessment tool is using those indicators or trends on a target document undergoing analysis by the risk assessment tool. For example, the scoring engine can provide an explanation such as “This patent application includes the use of the word ‘lethal’ at a rate of 1 per 1000 words; the use of this word at this rate has a strong correlation (although NOT a causal relation), with previous patent applications that have been issued a secrecy order. The scoring engine also can assign a partial score that contributes to the risk score, based on the level of correlation to risk, the rate of correlation, which contributes to the overall risk score of the target document. In an embodiment, the risk assessment tool identifies the indicators, which then enables the risk assessment tool to have the ability to flag future patent applications entering the system that have that key word indicator. These indicators help the risk assessment tool make reviews more efficient and effective, by weighing the correlating information of past (e.g., already-scored) high-risk vs. low-risk patent applications. The risk assessment tool tags target documents with contextual “indicators” that are associated with high-risk patents (or low-risk patents), as part of risk assessment and data analysis. The risk assessment tool has the ability to identify contextual indicators or trends (not just key words) in patent applications that have been given a SO in the past, e.g., based on AI tools or language analysis. As used herein, a “contextual indicator” represents an understanding by the risk assessment tool of the reason contributing to why a patent application previously had been selected or not selected for a SO, e.g., based on a human decision within the context of a larger decision-making framework as provided by the risk assessment tool. The risk assessment tool applies scoring and analysis to a test document based on understanding previous decisions, e.g., the “why” behind a decision that resulted in an SO, and turning that understanding into indicators for future identification of patent applications that also would need SOs. The risk assessment tool has the ability to flag future patent applications based on specific attributes (ex: impact on critical infrastructure), and also takes the indicators further and breaks it down to its relation to national security, whether based on likelihood, threat, impact, etc. The risk assessment tool identifies and finds indicators and flags, e.g., based on machine learning as applied to previous patent applications that were targeted by a secrecy order. The risk assessment tool also can identify such indicators and flags by using synthetic data or other options (e.g., using a curated set of training documents that exemplify the type of target document that would be subject to a secrecy order). This provides benefits such as furthering the ability to connect indicators with their relevancy to national security, refining data analytics to aid in decision-making processes, and speeding up review processes.

The risk assessment tool facilitates Secrecy Order Determinations by providing written explanations/reports about differences between a target document (e.g., patent application) and comparable patents in the public domain, e.g., as part of an initial assessment. The risk assessment tool provides an analysis summary/data to support SO decisions, which can be made available to users via a communication platform. Such reports provide the “why” behind the recommendation, and incorporate an explanation of the contextual analysis between patents (i.e., going beyond a mere comparison of words/phrases). In an embodiment, the risk assessment tool generates such reports to in a format that is explainable including contextual differences, i.e., by articulating the pieces that are already public as well as the ideas themselves.

In embodiments, the risk assessment tool serves as a source (e.g., collection point) for sources (articles, studies, reports, other patents/legal information) that inform the SO determination. For example, the communication platform searches available sources for information related to the patent application. The risk assessment tool can ingest and analyze this information for use in scoring a target document, and can make this information available for users to review. This approach supports data analysis capabilities by associating relevant information with ISA Reviews and the decisions made, supporting decision-making processes by consolidating relevant information.

The risk assessment tool can provide a dashboard of assessment data, and make the dashboard accessible by users. The risk assessment tool can extract information from the AI activities that pertain to a given target document (e.g., a patent application) including risk values, impact on national security and national economy, strategic value data, and objective standard information. The risk assessment tool can then use scoring engines to apply the extracted information in assessing the target document. The risk assessment tool also can make such extracted information available, e.g., via the communication platform, for inspection by users. This dashboard interface provides users with data that can be used to evaluate the effectiveness of the risk assessment tool, and enables the risk assessment tool to receive user-feedback or guidance accordingly to help fine-tune the risk assessment tool.

In an embodiment, the risk assessment tool provides (e.g., via the dashboard interface) a template/form for writing SO justifications, which the risk assessment tool can pre-configure so that the templates/forms capture the risk determination information as determined by the risk assessment tool. In an embodiment, the risk assessment tool provides the template for producing a Secrecy Order Justification including standard fields/sections and descriptions of section contents. The risk assessment tool auto-populates standard elements of the form to expedite the writing process and save time for the benefit of the user. The risk assessment tool can provide the form with a standardized justification format. The risk assessment tool also can provide the form including template (“canned”) paragraphs of text, to assist in the writing of the justification. In an embodiment, the risk assessment tool associates the canned text with specific reasoning, to support the issuance of a Secrecy Order. The risk assessment tool provides the ability to add citations to support the Secrecy Order Justification, and provides the ability to edit or customize the text. The risk assessment tool generates language that can be used in a Secrecy Order Justification, and can include language or other indications that relate directly to the patent application being reviewed. Thus, the risk assessment tool provides justification content and assists in the writing of good secrecy order justifications that can withstand legal scrutiny. This enables the risk assessment tool to reduce the potential for back-and-forth with legal reviews, and speeds up the overall process.

In an embodiment, the risk assessment tool auto-generates a justification based on a data repository of justification language, e.g., based on generative AI tailored by the risk assessment tool. The risk assessment tool can store a repository of justification language within the system (e.g., boilerplate), that the risk assessment tool pulls from to auto-generate a draft Secrecy Order Justification. The risk assessment tool also can enable compliance with data retention policies regarding non-used auto generated text from the data repository, e.g., enabling automatic or manual deletion of such text according to guidelines as to whether the information will be discoverable and related policies that affect data retention rules. The risk assessment tool also can use the data repository to generate necessary citations to support the justification. Such features enable the risk assessment tool to serve as a tool to help generate some text (e.g., via generative AI), that is a justification of a Secrecy Order requirement, while facilitating communication with users (e.g., via the communication platform) to enable a user to be “in the loop” to oversee editing, approval, and finalizing if the justification. The risk assessment tool trains and constrains the generative AI to follow all policy guidance, and prevent the generative AI from creating false information/references. The risk assessment tool thereby greatly speeds up the secrecy order justification writing process by enhancing the quality and content of the document. In an embodiment, the risk assessment tool supports the process of writing and reviewing a legally defensible secrecy order justification. The risk assessment tool can automatically generate required memos for SO related recommendations, and keep track of the history and latest version of the memos as part of the annual review process. The risk assessment tool thereby expedites the process, creates standardization, and improves quality.

The risk assessment tool can be used for data analysis, e.g., enabling the ability to capture justifications for why the SO was not issued. In an embodiment, the communication platform of the risk assessment tool provides a user interface (e.g., a dashboard) to capture user-based justifications submitted via free-text and/or user surveys. For example, the risk assessment tool creates a data repository of a justification for why a SO was not issued. The risk assessment tool can use the data repository to feed future artificial intelligence (AI)/machine language (ML) solutions to automatically replicate, e.g., a manual review process as set forth in the collected information in the data repository. The risk assessment tool also can use “synthetic data,” e.g., collected from patents that are in the public domain, to initially train the risk assessment tool system, prior to or in addition to capturing user information. The risk assessment tool can isolate such information for use in internal deliberations only, and data analysis, as needed (e.g., in situations that call for a human to make the decisions, even for patent applications that are not issued a Secrecy Order. The data repository enables the risk assessment tool to “reverse engineer” decisions (e.g., “Secrecy Not Recommended” decisions), to better determine and flag patent applications that are not a national security risk.

The risk assessment tool can identify contextual flags for patent applications that are not issued a SO. In an embodiment, the risk assessment tool performs analysis by a module that associates low-risk patents (e.g., from a training library repository) and contextualizes language used in those patents to flag patterns that fit the contextualized language patterns (e.g., using AI language models). The risk assessment tool can identify the contextual indicators within those patent applications that are not issued SO, and link these indicators to captured risk values to establish relevant understanding for the AI tool analysis. This feeds an understanding/accuracy of the AI-based approaches used in the risk assessment tool, providing a basis for reverse engineering the “Secrecy Not Recommended” decisions, to better determine and flag future patent applications that are not a national security risk. The risk assessment tool makes use of AI tools to help analyze the past patent applications that have not been issued a SO, to advance the learning of the AI solution for future patent applications. The analysis by the risk assessment tool provides information that is “actionable” to for decision-making purposes. In an embodiment, the risk assessment tool can mimic the decision-making tree of a human who would otherwise (absent the risk assessment tool) be manually performing a task of filtering out a PA for additional review. The risk assessment tool can generate a report that highlights any factors/language in the patent application (PA) that could contribute to selection of that as a PA for review.

The risk assessment tool also analyzes patent applications that have been issued a SO, to inform the AI tool analysis. For analysis of patents that have been issued an SO, the risk assessment tool can use similar approaches to those described above regarding patents/patent applications that have not been issued an SO. In an embodiment, the risk assessment tool analyzes PAs that receive a SO, and catalogs the results (e.g., using the training library repository). The risk assessment tool using AI tools to look for trends and patterns in these types of patents/patent applications, and use machine learning capabilities to help refine risk algorithms of the risk assessment tool, to more accurately determine if a technology is a national security risk.

The risk assessment tool can conduct trend analysis on patent applications and risk management data. In an embodiment, the risk assessment tool uses previous results to analyze the effectiveness of current queries and risk analysis approaches, catalogs results in a form that is usable, and creates feedback loops on the Risk Analysis process. Thus, the risk assessment tool analyzes processes and procedures to identify opportunities for more effective and efficient ways of doing things, e.g., identifies bottlenecks, inconsistencies among reviewers, improvements or degradation, and root cause analysis. In an embodiment, the risk assessment tool can determine whether the Patent Security Category Review List (PSCRL) could be updated, or if the Tech categories could be amended. For example, the risk assessment tool can include a feedback loop into the PSCRL, to reduce the number of referred patents and track and monitor what patents are being referred along with the decisions made, also affecting what the risk assessment tool will receive from the USPTO. The risk assessment tool can expand the aperture for technologies that are consistently deemed to be a risk to national security. The risk assessment tool can generate a report that makes recommendations (more complex AI) in updating the PSCRL, and can track the refinement process over time in comparison to an original starting point. By refining the aperture of the incoming patent applications, the risk assessment tool better targets the technologies of interest. This provides benefits of reducing the number of incoming patent applications that have nothing to do with national security, and/or increases the number of incoming patent applications regarding national security.

The risk assessment tool can analyze a wide variety of other patents to improve the AI intelligence used by the risk assessment tool. The risk assessment tool scans/analyzes patent applications throughout the world to acquire data. This aids and improves machine learning and artificial intelligence capability deployed by the risk assessment tool. In an embodiment, the risk assessment tool uses an AI tool based on a General Adversarial Network (GAN).

The risk assessment tool can provide different data analysis dashboards, for user interaction with the risk assessment tool:

### Patent Application Workbench Dashboard:

The Patent Application Workbench Dashboard of the risk assessment tool can display the following types of information relating to a patent application, including:

Display basic information:
Application Number, Title, etc.
Date Assigned, Due Date, and Days Remaining
Status of user review (e.g., currently under review by XXX reviewers, awaiting review, completed, etc.)
Tech Category, Keywords, CPC codes, etc.

Display relevant links to references:
Links are periodically refreshed, and broken links are identified and removed.
Related awarded patents from USPTO
Related technologies from websites with links to APIs
Cross-reference of inventor names/company owners/board members to the Consolidated Screening List (CSL) and provide any hits.
Any relevant threat reports that tie the technology of interest to any threats of interest to the Homeland.

Display indicators (not related to risk) that would suggest the patent application SHOULD NOT be issued a Secrecy Order, for example:
The information is already ubiquitous in the public domain
The patent application was likely referred in error (e.g., atomic fireball, nuclear submarine toilet seat, etc.)
Develop policy, protect it as “internal deliberation”
Other
The risk assessment tool can document these factors and to what a given factor might apply, such as by using an indication of clearly erroneous cases, or more marginal cases where the AI may be considered as more of an influence in the selection, etc.

Display indicators (not related to risk) that would suggest the patent application MIGHT be eligible for a Secrecy Order for example:
Contains keywords/phrases that are common amongst patent applications with Secrecy Orders (e.g., lethal, kill, exploit, impact radius, evade detection, etc.)
Company associations that are common among patent applications with Secrecy Orders (e.g., Lockheed Martin, Northrup Grumman, etc.)
Assigned to “Secretary of XXX” (e.g., Sec of Defense, Energy . . . ), other assignments or indicators including location, tech category, #pages, #diagrams, ratios of pages to diagrams, etc.

### Display the Risk Assessment Score

Likelihood and the reasons why
Impact and the reasons why
Ability to drill down to individual elements of likelihood and risk individually.

Display connections to sources of funding.

### ISA PMO Dashboard:

The ISA PMO Dashboard of the risk assessment tool can display the following types of information relating to a patent application, including:
Calculate and visualize days in review of all patent applications in review and identify relatively more important applications for focus.
Display case assignments distribution and provide the ability to drill down to various levels of hierarchy to illustrate bottlenecks and/or skewed distribution curves for the purposes of analysis and decision making.
Display case assignments by status
Display patent applications by Technology Category.
Count and Display results of ISA Review: Secrecy Order, No Secrecy Order, Annual Review, rescission decisions, etc.
Provide a summary of the number of secrecy orders recommended across Total Applications Processed.

The risk assessment tool provides reporting, e.g., by generating a report. The risk assessment tool can (e.g., via the communication platform) send a report with a final status of all PAs to the USPTO. The risk assessment tool can generate canned reports and ad hoc reports, in various formats including MS Word, Excel, Power Point, PDF, and the like.

In an embodiment, the risk assessment tool can generate a report including patent applicant information in the style of a letter that gives the applicant/company a read-out that the application was evaluated, the report including a section allowing the applicant/company to submit questions, and provide resources informing the applicant/company to learn more on how to protect themselves. E.g., technology protection plan, resources, contact information. “coming from the perspective of Intellectual Property theft.”

In an embodiment, the risk assessment tool can generate a report for applications that have “Secrecy Not Recommended.” The risk assessment tool can generate a standard letter noting that the applicant's application has been reviewed under the ISA authority and a secrecy order is not being recommended. The communication platform of the risk assessment tool can send the letter directly to the applicant and/or the USPTO for distribution.

In an embodiment, the risk assessment tool can generate a report providing identification of redactable information to not impose a secrecy order. The risk assessment tool generates the report identifying important aspects of the patent application that are considered sensitive to national security. The risk assessment tool can determine if the removal (redactions) of those particular aspects of information would leave enough core subject matter unaffected, to enable the application to still meet a sufficient subject matter threshold to be eligible for the patent examination process. The risk assessment tool can communicate the report of this information to the inventor/applicant, informing the inventor/application that they could then resubmit their application after redacting the particular aspects of information that are sensitive.

The risk assessment tool can use its likelihood scoring engine to identify funding sources (e.g., foreign funded, university, etc.). The risk assessment tool can perform this identification as part of an initial assessment. For example, the likelihood scoring engine can identify the funding source/affiliations of the inventor, determine if the information impacts the SO determination, determine if the patent application should be referred to another organization, and determine whether a data set of sponsors/rogue actors is needed to determine if the patent should be flagged.

The risk assessment tool provides user interfaces, to facilitate user participation and input (e.g., via dashboards or other interfaces described herein). The risk assessment tool can take advantage of the user input to help tailor the deployment of the various processes used by the risk assessment tool. An illustrative example is provided, involving a potential challenge associated with using human input for the review of example patents to be assigned to Class 1, Class 2, Class 3. The user can read an unclassified patent, and determine whether the unclassified patent would be more similar to Class 1, Class 2, or Class 3. However, the human user brings in biases, which can affect the user's experience in review, experience with technology, unique life experiences, etc. This creates a problem that user A might classify an unclassified patent as Class 1, but user B could classify that unclassified patent as Class 2, risking different outcomes for the same unclassified patent. The risk assessment tool can involve target documents pertaining to national security (in some configurations). Accordingly, the correct and consistent classification of target documents may be very important. The approaches used by the risk assessment tool provide consistency and reliability.

The risk assessment tool can be customized and tailored to address different specific categories, such as economy settings including: counterfeiting technology, artificial intelligence, software hacking methods, and trade secrets/knowledge that should remain secret from the rest of the world. The risk assessment tool can be tailored to address security concerns for the individual vs nation-state, including homemade explosives harmful at the individual level, but not likely at the nation-state level; and nuclear weapons that might impact nation-states, but remain beyond the reach of individual bad actors.

The software implementation of the risk assessment tool can be programmed for particular suitability to address individuals, groups, and nation-states (e.g., by using corresponding suitable training sets or training library datasets) with relative terminology for training the AI aspects of the risk assessment tool. The software implementation of the risk assessment tool can be configured to analyze specific individuals, groups, and nations because their interests and capabilities can be so divergent. The risk assessment tool can accept customization inputs where values/intelligence for these entities/parties can be updated (in real time). These values cause the risk assessment tool to affect the ultimate risk determinations and underlying values, because the determination can affect whether something is of interest, expensive, requires particular materials, is a party specific determination because of the use of relative terminology, or has a particular level of expense (e.g., whether the technology is within economic range of a single person, a group, a nation state, or somewhere along that spectrum). The risk assessment tool can be configured to process intelligence changes in real time on individuals, groups, and nation states. The risk assessment tool can be programmed so that execution by multiple different machines (or processors) will yield the same result, in contrast to human-based classification approaches affected by human biases. The performance of the risk assessment tool, such as its various algorithms, can be updated through adjusting the source data at any time, unlike human reviewers who have human memory that cannot be reset by simply providing them a new list of source materials.

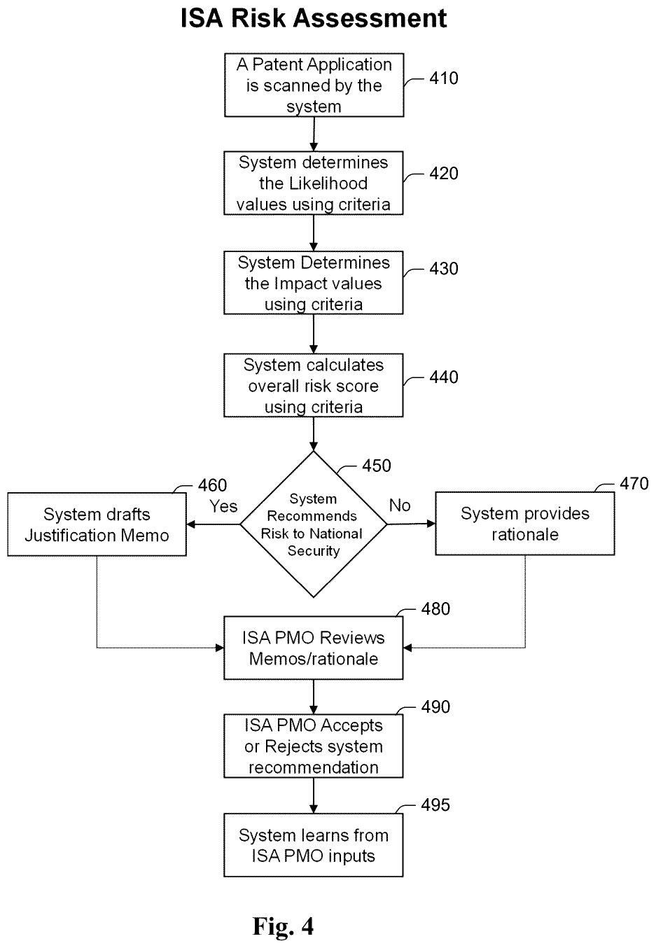

FIG. 4 illustrates a process flow for risk assessment according to an embodiment. In block 410, a patent application is scanned by the risk assessment tool system. In block 420, the risk assessment tool system determines the likelihood values using criteria. For example, the risk assessment tool uses the example likelihood criteria set forth above in Table 1. In block 430, the risk assessment tool system determines the impact values using criteria. For example, the risk assessment tool uses the example impact criteria set forth above in Table 2. In block 440, the risk assessment tool system calculates an overall risk score using criteria. In an embodiment, the risk assessment tool uses the risk scoring engine to calculate the overall risk score. In block 450, the risk assessment tool system determines whether to recommend that the target document poses a risk to national security. If yes the target document poses a risk to national security, flow proceeds to block 460. In block 460, the risk assessment tool system drafts a justification memo and flow proceeds to block 480. If, at block 450 the risk assessment tool system determines that no, the system does not recommend the risk, flow proceeds to block 470. In block 470, the risk assessment tool system provides a rationale and flow proceeds to block 480. In block 480, the risk assessment tool system provides a user interface to facilitate user review (e.g., ISA PMO) of the target document patent application. For example, the risk assessment tool system generates a dashboard to present the user with the target document for review. In block 490, the risk assessment tool system receives the user input from the user indicating acceptance or rejection of the system recommendation. For example, the risk assessment tool system automatically scores the target document and generates a corresponding system recommendation regarding whether to subject the target document to a secrecy order. The risk assessment tool system then presents the system recommendation to the user. In block 495, the risk assessment tool system learns from the user input. For example, the risk assessment tool system can receive the user input as a binary accept or reject of the system recommendation, and incorporate the user input as feedback to help the risk assessment tool system learn and adapt.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

For instances in which the systems and/or methods discussed here may collect personal information about users, or may make use of personal information, the users may be provided with an opportunity to control whether programs or features collect personal information, e.g., information about a user's social network, social actions or activities, profession, preferences, or current location, or to control whether and/or how the system and/or methods can perform operations more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained, such as to a city, ZIP code, or state level, so that a particular location of a user cannot be determined. Thus, the user may have control over how information is collected about him or her and used.

Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing system” encompasses all apparatus, devices, and machines for processing data, including by way of example a programmable processor, a computer, or multiple processors or computers. The system may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Embodiments and functional operations described in this specification may be implemented in digital electronic circuitry, or in computer software, firmware, or hardware, including the structures disclosed in this specification and their structural equivalents, or in combinations of one or more of them. For example, elements designated as engines, generators, identifiers, tools, analyzers, calculators, classifiers, checkers, finders, logic recorders, visualizers, aggregators, modules, nodes, managers, organizers, algorithms, etc. may be implemented in a variety of ways. A computer program (also known as a program, software, software application, script, or code) may be written in any form of programming language, including compiled or interpreted languages, and it may be deployed in any form, including as a standalone program or as a module, component, subroutine, or other unit suitable for use in a computing environment.

A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

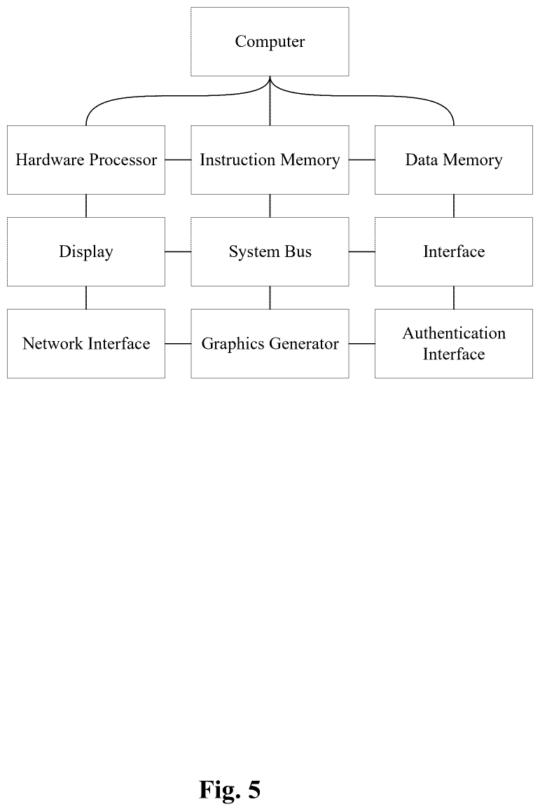

FIG. 5 illustrates a schematic diagram of a computer. The computer includes one or more of a hardware processor, instruction memory, data memory, display, system bus, interface, network interface, graphics generator, and authentication interface. The processor is for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide interaction with a user, embodiments may be implemented on a computer having a display device, like a TV or monitor (CRT or LCD, etc.) for displaying information to the user. Computers may have peripherals like a keyboard, trackpad, mouse, etc. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computer and/or computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular embodiments have been described. Other embodiments are within the scope of the following claims. For example, the actions recited in the claims may be performed in a different order and still achieve desirable results.

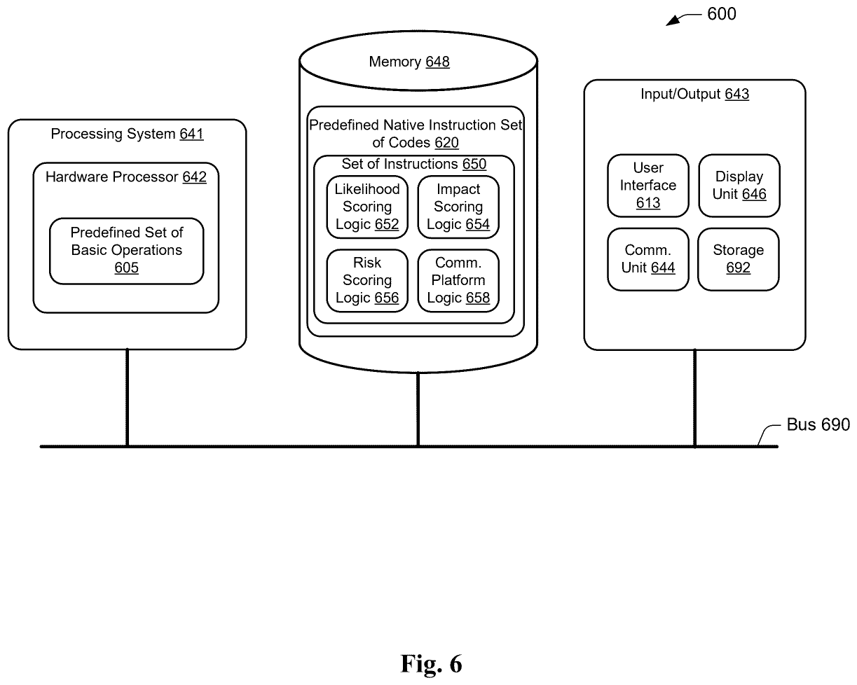

FIG. 6 illustrates a diagram of a computer system 600 according to an embodiment. The computer system 600 includes a processing system 641, memory 648, and input/output module 643 communicatively coupled via bus 690. The processing system 641 includes hardware processor 642. The hardware processor 642 includes predefined set of basic operations 605. The memory 648 includes predefined native instruction set of codes 620. The predefined native instruction set of codes 620 includes a set of instructions 650. The set of instructions 650 includes likelihood scoring engine logic 652, impact severity scoring engine logic 654, risk scoring engine logic 656, and communication platform logic 658. The input/output 643 includes user interface 613, display unit 646, communication unit 644, and storage 692. In an embodiment, such components may serve as the computer system including the logic that carries out the methods described herein.

Certain attributes, functions, steps of methods, or sub-steps of methods described herein may be associated with physical structures or components, such as a module of a physical device that, in implementations in accordance with this disclosure, make use of instructions (e.g., computer executable instructions) that are embodied in hardware, such as an application specific integrated circuit, computer-readable instructions that cause a computer (e.g., a general-purpose computer) executing the instructions to have defined characteristics, a combination of hardware and software such as processor implementing firmware, software, and so forth so as to function as a special purpose computer with the ascribed characteristics. For example, in embodiments a module may comprise a functional hardware unit (such as a self-contained hardware or software or a combination thereof) designed to interface the other components of a system such as through use of an API. In embodiments, a module is structured to perform a function or set of functions, such as in accordance with a described algorithm. This disclosure may use nomenclature that associates a component or module with a function, purpose, step, or sub-step to identify the corresponding structure which, in instances, includes hardware and/or software that function for a specific purpose. For any computer-implemented embodiment, “means plus function” elements will use the term “means;” the terms “logic” and “module” and the like have the meaning ascribed to them above, if any, and are not to be construed as means.

### Relationship Between Hardware Processor and Executable Program Code

The relationship between the executable program code in the instruction memory and the hardware processor is structural; the executable program code is provided to the hardware processor by imparting various voltages at certain times across certain electrical connections, in accordance with binary values in the executable program code, to cause the hardware processor to perform some action, as now explained in more detail.

A hardware processor may be thought of as a complex electrical circuit that is configured to perform a predefined set of basic operations in response to receiving a corresponding basic instruction selected from a predefined native instruction set of codes.

The predefined native instruction set of codes is specific to the hardware processor; the design of the processor defines the collection of basic instructions to which the processor will respond, and this collection forms the predefined native instruction set of codes.

A basic instruction may be represented numerically as a series of binary values, in which case it may be referred to as a machine code. The series of binary values may be represented electrically, as inputs to the hardware processor, via electrical connections, using voltages that represent either a binary zero or a binary one. These voltages are interpreted as such by the hardware processor.

Executable program code may therefore be understood to be a set of machine codes selected from the predefined native instruction set of codes. A given set of machine codes may be understood, generally, to constitute a module. A set of one or more modules may be understood to constitute an application program or “app.” An app may interact with the hardware processor directly or indirectly via an operating system. An app may be part of an operating system.

### Computer Program Product

A computer program product is an article of manufacture that has a computer-readable medium with executable program code that is adapted to enable a processing system to perform various operations and actions. Stated differently, the executable program code can embody or comprise instructions that cause a computer, e.g., that cause the processor, to perform particular operations or processes.

A computer-readable medium may be transitory or non-transitory. A transitory computer-readable medium may be thought of as a conduit by which executable program code may be provided to a computer system, a short-term storage that may not use the data it holds other than to pass it on.

The buffers of transmitters and receivers that briefly store only portions of executable program code when being downloaded over the Internet is one example of a transitory computer-readable medium. A carrier signal or radio frequency signal, in transit, that conveys portions of executable program code over the air or through cabling such as fiber-optic cabling provides another example of a transitory computer-readable medium. Transitory computer-readable media convey parts of executable program code on the move, typically holding it long enough to just pass it on.

Non-transitory computer-readable media may be understood as a storage for the executable program code. Whereas a transitory computer-readable medium holds executable program code on the move, a non-transitory computer-readable medium is meant to hold executable program code at rest. Non-transitory computer-readable media may hold the software in its entirety, and for longer duration, compared to transitory computer-readable media that holds only a portion of the software and for a relatively short time. The term, “non-transitory computer-readable medium,” specifically excludes communication signals such as radio frequency signals in transit.

The following forms of storage exemplify non-transitory computer-readable media: removable storage such as a universal serial bus (USB) disk, a USB stick, a flash disk, a flash drive, a thumb drive, an external solid-state storage device (SSD), a compact flash card, a secure digital (SD) card, a diskette, a tape, a compact disc, an optical disc; secondary storage such as an internal hard drive, an internal SSD, internal flash memory, internal non-volatile memory, internal dynamic random-access memory (DRAM), read-only memory (ROM), random-access memory (RAM), and the like; and the primary storage of a computer system.

Different terms may be used to express the relationship between executable program code and non-transitory computer-readable media. Executable program code may be written on a disc, embodied in an application-specific integrated circuit, stored in a memory chip, or loaded in a cache memory, for example. Herein, the executable program code may be said, generally, to be “in” or “on” a computer-readable media. Conversely, the computer-readable media may be said to store, to include, to hold, or to have the executable program code.

### Creation of Executable Program Code

Software source code may be understood to be a human-readable, high-level representation of logical operations. Statements written in the C programming language provide an example of software source code.

Software source code, while sometimes colloquially described as a program or as code, is different from executable program code. Software source code may be processed, through compilation for example, to yield executable program code. The process that yields the executable program code varies with the hardware processor; software source code meant to yield executable program code to run on one hardware processor made by one manufacturer, for example, will be processed differently than for another hardware processor made by another manufacturer.

The process of transforming software source code into executable program code is known to those familiar with this technical field as compilation or interpretation and is not the subject of this application.

### User Interface

A computer system may include a user interface controller under control of the processing system that displays a user interface in accordance with a user interface module, i.e., a set of machine codes stored in the memory and selected from the predefined native instruction set of codes of the hardware processor, adapted to operate with the user interface controller to implement a user interface on a display device. Examples of a display device include a television, a projector, a computer display, a laptop display, a tablet display, a smartphone display, a smart television display, or the like.

The user interface may facilitate the collection of inputs from a user. The user interface may be graphical user interface with one or more user interface objects such as display objects and user activatable objects. The user interface may also have a touch interface that detects input when a user touches a display device.

A display object of a user interface may display information to the user. A user activatable object may allow the user to take some action. A display object and a user activatable object may be separate, collocated, overlapping, or nested one within another. Examples of display objects include lines, borders, text, images, or the like. Examples of user activatable objects include menus, buttons, toolbars, input boxes, widgets, and the like.

### Communications

The various networks are illustrated throughout the drawings and described in other locations throughout this disclosure, can comprise any suitable type of network such as the Internet or a wide variety of other types of networks and combinations thereof. For example, the network may include a wide area network (WAN), a local area network (LAN), a wireless network, an intranet, the Internet, a combination thereof, and so on. Further, although a single network is shown, a network can be configured to include multiple networks.

### Considerations

For any computer-implemented embodiment, “means plus function” elements will use the term “means;” the terms “logic” and “module” have the meaning ascribed to them above and are not to be construed as generic means. An interpretation under 35 U.S.C. § 112 (f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, or devices to those appearing in any section. Rather, the teachings and disclosures herein can be combined or rearranged with other portions of this disclosure and the knowledge of one of ordinary skill in the art. It is intended that this disclosure encompass and include such variation.

The indication of any elements or steps as “optional” does not indicate that all other or any other elements or steps are mandatory. The claims define the invention and form part of the specification. Limitations from the written description are not to be read into the claims.

Certain attributes, functions, steps of methods, or sub-steps of methods described herein may be associated with physical structures or components, such as a module of a physical device that, in implementations in accordance with this disclosure, make use of instructions (e.g., computer executable instructions) that may be embodied in hardware, such as an application specific integrated circuit, or that may cause a computer (e.g., a general-purpose computer) executing the instructions to have defined characteristics. There may be a combination of hardware and software such as processor implementing firmware, software, and so forth so as to function as a special purpose computer with the ascribed characteristics. For example, in embodiments a module may comprise a functional hardware unit (such as a self-contained hardware or software or a combination thereof) designed to interface the other components of a system such as through use of an application programming interface (API). In embodiments, a module is structured to perform a function or set of functions, such as in accordance with a described algorithm. This disclosure may use nomenclature that associates a component or module with a function, purpose, step, or sub-step to identify the corresponding structure which, in instances, includes hardware and/or software that function for a specific purpose. For any computer-implemented embodiment, “means plus function” elements will use the term “means;” the terms “logic” and “module” and the like have the meaning ascribed to them above, if any, and are not to be construed as means.

While certain implementations have been described, these implementations have been presented by way of example only and are not intended to limit the scope of this disclosure. The novel devices, systems and methods described herein may be embodied in a variety of other forms; furthermore, various omissions, substitutions, and changes in the form of the devices, systems and methods described herein may be made without departing from the spirit of this disclosure.

The various subtitles in the application are inserted to assist the Office in navigation of the application only. The titles should not be considered limited in anyway and should be considered when interpreting the scope of any claim elements. Details on any particular claim element may appear in sections of the application not specifically noted by an associated title.

The claimed subject matter is:

1. A risk assessment tool comprising:
a target document comprising target technology; the target document written by an author; the target document publishable by a publisher;
a document translator configured to:
determine a language of the target document;
translate the language of the target document to a second language when the document is written in a language other than the second language;
a target document integrity verification tool configured to:
determine whether the target document contains data in all standard data fields;
mark the target document as complete if the document contains data in all standard data fields;
mark the target document as incomplete if the document does not contain data in all standard data fields;
a priority claim analyzer configured to:
determine there is a foreign priority claim in the target document;
update the target document record to record the foreign priority claim;
a likelihood scoring engine configured to:
determine an expertise score based on expertise required to implement the target technology;
determine an acquisition capability score based on whether material and components could be readily acquired to implement the target technology;
determine a fundability score based on an amount of funding required to implement the target technology;
determine a disclosure sufficiency score based on how much disclosure details are missing from the document;
determine an interest score based on known or suspected interest levels in the technology to an adverse party;
generate a likelihood score by performing a first mathematical operation on the expertise score, acquisition capability score, fundability score, disclosure sufficiency score, and interest score; the likelihood score indicating how likely that technology in the target document will be used or adopted by the adverse party in a way that is harmful to a protected party;
an impact severity scoring engine configured to:
determine a health security impact score indicating a severity of impact to health security of individuals in the protected party when the target technology is implemented by the adverse party;
determine a critical infrastructure score indicating a severity of impact to critical infrastructure of the protected party when the target technology is implemented by the adverse party;
determine a business operation interference score indicating a severity of impact to business operations of the protected party when the target technology is implemented by the adverse party;
generate an impact severity score by performing a second mathematical operation on the health security impact score; critical infrastructure score; and business operation interference score; the impact severity score indicating a severity of impact to the protected party when the adverse party implements the target technology;
a risk scoring engine for determining an overall risk score to the protected party; the risk scoring engine configured to:
generate a risk threshold curve on a graph having axes;
determine the risk score is below the risk threshold when the impact severity score and the likelihood score as expressed as a coordinate on the graph falls within an area bound by axes of the graph and the risk curve; and
determine the risk score is above the risk threshold when the impact severity score and the likelihood score as expressed as a coordinate on the graph does not fall within the area bound by axes of the graph and the risk curve;
a communication platform configured to:
generate a draft secrecy order to the author or publisher not to publish the paper when the overall risk score is above the risk threshold;
send the draft secrecy order to a third party computer;
receive an approval from the third party computer to transmit the secrecy order;
generate a final secrecy order;
generate a communication to the author or publisher comprising the final secrecy order; the communication identifying the target document is subject to a secrecy order;
send the communication to the author or publisher;
edit the target document record to record that the target document has been reviewed by the risk assessment tool; and
edit the target document record to record that the communication has been sent to the author or publisher.

2. The risk assessment tool of claim 1 wherein the likelihood scoring engine is further configured to:
assign the target technology a design complexity rank of complex, moderate, or simple;
set a numerical equivalent for high, medium, and low, wherein the numerical equivalent for high is greater than the numerical equivalent for medium, and the numerical equivalent for medium is greater than numerical equivalent for low;
set expertise score as low when the target technology has a design complexity ranked complex;
set expertise score as medium when the target technology has a design complexity ranked medium; and
set expertise score as high when the target technology has a design complexity ranked simple.

3. The risk assessment tool of claim 2 wherein the likelihood scoring engine is further configured to:
assign the target technology a skill level rank of advanced, average, or simple;
set expertise score as low when the target technology has a technology skill level of advanced;
set expertise score as medium when the target technology has a technology skill level of average; and
set expertise score as high when the target technology has a technology skill level of simple.

4. The risk assessment tool of claim 3 wherein the likelihood scoring engine is further configured to:
assign the target technology a skill level rank of advanced when the target technology requires a subject matter expert with unique and specialized backgrounds that are not readily available;
assign the target technology a skill level rank of moderate when the target technology requires a technical background and an understanding of the target technology obtainable with moderate difficulty;
assign the target technology a skill level rank of simple when target technology can be implemented by an individual without prior background or knowledge of the technology.

5. The risk assessment tool of claim 1 wherein the impact severity scoring engine is further configured to:
determine an expected number of people are likely to be impacted by implementation of the target technology;
assign the healthy security impact value a low score when the expected number of people is below X persons;
assign the healthy security impact value a medium score when the expected number of people is below Y persons, but above X persons;
assign the healthy security impact value a high score when the expected number of people is below Z persons, but above Y persons;
assign the healthy security impact value a catastrophic score when the expected number of people is above Z persons;
set a numerical equivalent for catastrophic, high, medium, and low, wherein the numerical equivalent for catastrophic is greater than numerical equivalent for high, the numerical equivalent for high is greater than the numerical equivalent for medium, and the numerical equivalent for medium is greater than numerical equivalent for low; and
set Z greater than Y and Y greater than X; wherein X, Y, Z are natural numbers.

6. The risk assessment tool of claim 1 wherein the impact severity scoring engine is further configured to:
determine an expected severity of health impact for individuals in the protected party through implementation of the target technology by the adverse party;
assign the healthy security impact value a low score when the expected severity of health impact includes mild health implications for a small number of individuals;
assign the healthy security impact value a medium score when the expected severity of health impact includes:
moderate health implications for a moderate number of individuals;
moderate health implications for a small number of individuals; or
mild health implications for a moderate number of individuals;
assign the healthy security impact value a high score when the expected severity of health impact includes:
severe health implications or long term health implications for a high number of individuals;
severe health implications or long term health implications for a medium number of individuals;
severe health implications or long term health implications for a small number of individuals; or
mild or moderate health implications for a large number of individuals;
assign the healthy security impact value a catastrophic score when the expected severity of health impact includes:
loss of life for any number of individuals; and
mild, moderate, severe or long term health implications for a catastrophic number of individuals; and
set a numerical equivalent for catastrophic, high, medium, and low, wherein the numerical equivalent for catastrophic is greater than numerical equivalent for high, the numerical equivalent for high is greater than the numerical equivalent for medium, and the numerical equivalent for medium is greater than numerical equivalent for low.

7. A method of risk assessment comprising:
determining, by a likelihood scoring engine, an expertise score based on expertise required to implement the target technology;
determining, by the likelihood scoring engine, an acquisition capability score based on whether material and components could be readily acquired to implement the target technology;
determining, by the likelihood scoring engine, a fundability score based on an amount of funding required to implement the target technology;
determining, by the likelihood scoring engine, a disclosure sufficiency score based on how much disclosure details are missing from the target document, wherein the target document includes target technology, the target document written by an author; the target document publishable by a publisher;
determining, by the likelihood scoring engine, an interest score based on known or suspected interest levels in the technology to an adverse party;
generating, by the likelihood scoring engine, a likelihood score by performing a first mathematical operation on the expertise score, acquisition capability score, fundability score, disclosure sufficiency score, and interest score; the likelihood score indicating how likely that technology in the target document will be used or adopted by the adverse party in a way that is harmful to a protected party;
determining, by a national security analyzer of an impact severity scoring engine, an impact to national security score associated with publication of the target document;
determining, by a national economy analyzer of the impact severity scoring engine, an impact to national economy score associated with publication of the target document; and
determining, by a strategic importance analyzer of the impact severity scoring engine, strategic importance score for the targeted technology to an adverse party;
generating, by the impact severity scoring engine, an impact severity score by performing a second mathematical operation on the impact to national security score; impact to national economy score; and strategic importance score; the impact severity score indicating a severity of impact to the protected party when the adverse party implements the target technology;
determining, by a risk scoring engine, an overall risk score to the protected party;
generating, by the risk scoring engine, a risk threshold curve on a graph having axes;
determining, by the risk scoring engine, the overall risk score to the protected party is below the risk threshold when the impact severity score and the likelihood score as expressed as a coordinate on the graph falls within an area bound by axes of the graph and the risk curve;
determining, by the risk scoring engine, the overall risk score to the protected party above the risk threshold when the impact severity score and the likelihood score as expressed as a coordinate on the graph does not fall within the area bound by axes of the graph and the risk curve;
issuing, by the risk scoring engine, a secrecy order to the author or publisher not to publish the paper when the risk score is above the risk threshold; and
generating, by a communication platform, a communication to the author or publisher;
the communication identifying the document is subject to a secrecy order; sending the communication to the author or publisher; editing document record to record that the communication has been sent to the author or publisher.

8. The method of risk assessment of claim 7, further comprising maintaining a training library; the training library comprising:
a first set of training documents having a high impact on national security rank; the high impact on national security rank determined by a human;
a second set of training documents having a medium impact on national security rank determined by a human; the medium impact on national security rank determined by a human; and
a third set of training documents having a low impact on national security rank determined by a human; the low impact on national security rank determined by a human.

9. The method of risk assessment of claim 8, further comprising:
determining, by the national security analyzer, a national security similarity level of the target document as compared to the first set, second set, and third set of training documents;
setting, by the national security analyzer, a numerical equivalent for high, medium, and low, wherein the numerical equivalent for high is greater than the numerical equivalent for medium, and the numerical equivalent for medium is greater than numerical equivalent for low;
setting, by the national security analyzer, the impact to national security score as high when the target document is more similar to the first set of training documents;
setting, by the national security analyzer, the impact to national security score as medium when the target document is more similar to the second set of training documents; and
setting, by the national security analyzer, the impact to national security score as low when the target document is more similar to the third set of training documents.

10. The method of risk assessment of claim 7, comprising maintaining a training library; the training library comprising:
a first set of training documents having a high impact on national economy rank; the high impact on national economy rank determined by a human;
a second set of training documents having a medium impact on national economy rank determined by a human; the medium impact on national economy rank determined by a human; and
a third set of training documents having a low impact on national economy rank determined by a human; the low impact on national economy rank determined by a human.

11. The method of risk assessment of claim 10, further comprising:
determining, by the national economy analyzer, a national economy similarity level of the target document as compared to the first set, second set, and third set of training documents;
setting, by the national economy analyzer, a numerical equivalent for high, medium, and low, wherein the numerical equivalent for high is greater than the numerical equivalent for medium, and the numerical equivalent for medium is greater than numerical equivalent for low;
setting, by the national economy analyzer, the impact to national economy score as high when the target document is more similar to the first set of training documents;
setting, by the national economy analyzer, the impact to national economy score as medium when the target document is more similar to the second set of training documents; and
setting, by the national economy analyzer, the impact to national economy score as low when the target document is more similar to the third set of training documents.

12. The method of risk assessment of claim 7, comprising maintaining a training library; the training library comprising:
a first set of training documents having a high impact on strategic importance rank; the high impact on strategic importance rank determined by a human;
a second set of training documents having a medium impact on strategic importance rank determined by a human; the medium impact on strategic importance rank determined by a human; and
a third set of training documents having a low impact on strategic importance rank determined by a human; the low impact on strategic importance rank determined by a human.

13. The method of risk assessment of claim 12, further comprising:
determining, by the strategic importance analyzer, a strategic importance similarity level of the target document as compared to the first set, second set, and third set of training documents;
setting, by the strategic importance analyzer, a numerical equivalent for high, medium, and low, wherein the numerical equivalent for high is greater than the numerical equivalent for medium, and the numerical equivalent for medium is greater than numerical equivalent for low;
setting, by the strategic importance analyzer, the impact to strategic importance score as high when the target document is more similar to the first set of training documents;
setting, by the strategic importance analyzer, the impact to strategic importance score as medium when the target document is more similar to the second set of training documents; and
setting, by the strategic importance analyzer, the impact to strategic importance score as low when the target document is more similar to the third set of training documents.

14. A tangible non-transitory computer-readable medium having stored thereon computer-executable instructions that, if executed by a computing device, cause the computing device to:
determine, by a likelihood scoring engine, an expertise score based on expertise required to implement the target technology;
determine, by the likelihood scoring engine, an acquisition capability score based on whether material and components could be readily acquired to implement the target technology;
determine, by the likelihood scoring engine, a fundability score based on an amount of funding required to implement the target technology;
determine, by the likelihood scoring engine, a disclosure sufficiency score based on how much disclosure details are missing from the target document,
wherein the target document includes target technology, the target document written by an author; the target document publishable by a publisher;
determine, by the likelihood scoring engine, an interest score based on known or suspected interest levels in the technology to an adverse party;
generate, by the likelihood scoring engine, a likelihood score by performing a first mathematical operation on the expertise score, acquisition capability score, fundability score, disclosure sufficiency score, and interest score; the likelihood score indicating how likely that technology in the target document will be used or adopted by the adverse party in a way that is harmful to a protected party;
determine, by a national security analyzer of an impact severity scoring engine, an impact to national security score associated with publication of the target document;
determine, by a national economy analyzer of the impact severity scoring engine, an impact to national economy score associated with publication of the target document; and
determine, by a strategic importance analyzer of the impact severity scoring engine, strategic importance score for the targeted technology to an adverse party;
generate, by the impact severity scoring engine, an impact severity score by performing a second mathematical operation on the impact to national security score; impact to national economy score; and strategic importance score; the impact severity score indicating a severity of impact to the protected party when the adverse party implements the target technology;
determine, by a risk scoring engine, an overall risk score to the protected party;
generate, by the risk scoring engine, a risk threshold curve on a graph having axes;
determine, by the risk scoring engine, the overall risk score to the protected party is below the risk threshold when the impact severity score and the likelihood score as expressed as a coordinate on the graph falls within an area bound by axes of the graph and the risk curve;
determine, by the risk scoring engine, the overall risk score to the protected party above the risk threshold when the impact severity score and the likelihood score as expressed as a coordinate on the graph does not fall within the area bound by axes of the graph and the risk curve;
issue, by the risk scoring engine, a secrecy order to the author or publisher not to publish the paper when the risk score is above the risk threshold; and
generate, by a communication platform, a communication to the author or publisher; the communication identifying the document is subject to a secrecy order; sending the communication to the author or publisher; editing document record to record that the communication has been sent to the author or publisher.

15. The tangible non-transitory computer-readable medium of claim 14, further comprising a training library comprising:
a first set of training documents having a high impact on national security rank; the high impact on national security rank determined by a human;
a second set of training documents having a medium impact on national security rank determined by a human; the medium impact on national security rank determined by a human; and
a third set of training documents having a low impact on national security rank determined by a human; the low impact on national security rank determined by a human.

16. The tangible non-transitory computer-readable medium of claim 15, the instructions further causing the computing device to:
determine, by the national security analyzer, a national security similarity level of the target document as compared to the first set, second set, and third set of training documents;
set, by the national security analyzer, a numerical equivalent for high, medium, and low, wherein the numerical equivalent for high is greater than the numerical equivalent for medium, and the numerical equivalent for medium is greater than numerical equivalent for low;
set, by the national security analyzer, the impact to national security score as high when the target document is more similar to the first set of training documents;
set, by the national security analyzer, the impact to national security score as medium when the target document is more similar to the second set of training documents; and
set, by the national security analyzer, the impact to national security score as low when the target document is more similar to the third set of training documents.

17. The tangible non-transitory computer-readable medium of claim 14, comprising a training library comprising:
a first set of training documents having a high impact on national economy rank; the high impact on national economy rank determined by a human;
a second set of training documents having a medium impact on national economy rank determined by a human; the medium impact on national economy rank determined by a human; and
a third set of training documents having a low impact on national economy rank determined by a human; the low impact on national economy rank determined by a human.

18. The tangible non-transitory computer-readable medium of claim 17, the instructions further causing the computing device to:
determine, by the national economy analyzer, a national economy similarity level of the target document as compared to the first set, second set, and third set of training documents;
set, by the national economy analyzer, a numerical equivalent for high, medium, and low, wherein the numerical equivalent for high is greater than the numerical equivalent for medium, and the numerical equivalent for medium is greater than numerical equivalent for low;
set, by the national economy analyzer, the impact to national economy score as high when the target document is more similar to the first set of training documents;
set, by the national economy analyzer, the impact to national economy score as medium when the target document is more similar to the second set of training documents; and
set, by the national economy analyzer, the impact to national economy score as low when the target document is more similar to the third set of training documents.

19. The tangible non-transitory computer-readable medium of claim 14, further comprising a training library comprising:
a first set of training documents having a high impact on strategic importance rank; the high impact on strategic importance rank determined by a human;
a second set of training documents having a medium impact on strategic importance rank determined by a human; the medium impact on strategic importance rank determined by a human; and
a third set of training documents having a low impact on strategic importance rank determined by a human; the low impact on strategic importance rank determined by a human.

20. The tangible non-transitory computer-readable medium of claim 19, the instructions further causing the computing device to:
determine, by the strategic importance analyzer, a strategic importance similarity level of the target document as compared to the first set, second set, and third set of training documents;
set, by the strategic importance analyzer, a numerical equivalent for high, medium, and low, wherein the numerical equivalent for high is greater than the numerical equivalent for medium, and the numerical equivalent for medium is greater than numerical equivalent for low;
set, by the strategic importance analyzer, the impact to strategic importance score as high when the target document is more similar to the first set of training documents;
set, by the strategic importance analyzer, the impact to strategic importance score as medium when the target document is more similar to the second set of training documents; and
set, by the strategic importance analyzer, the impact to strategic importance score as low when the target document is more similar to the third set of training documents.
